(19) United States
(12) Patent Application Publication
(10) Pub. No.: US 2026/0360363 A1
(43) Pub. Date: Nov. 12, 2026

(54) SYSTEM AND METHODS FOR VOICE-DRIVEN ANNOTATION OF SHARED SCREEN IN VIDEO CONFERENCES

(71) Applicant: Adeia Guides Inc., San Jose, CA (US)

(72) Inventors: Dhananjay Lal, Englewood, CO (US); Reda Harb, Saint Petersburg, FL (US); Aldis Sipolins, Somerville, MA (US)

(21) Appl. No.: 19/204,070

(22) Filed: May 9, 2025

(51) Int. Cl. G10L 15/26; G01S 17/89; G06F 3/01; G06V 40/10; G06V 40/20; G10L 15/18; H04N 7/15

(52) U.S. Cl. CPC G10L 15/26; G01S 17/89; G06F 3/017; G06V 40/10; G06V 40/28; G10L 15/1815; G10L 15/1822; H04N 7/15

(57) ABSTRACT

Automatic annotation of media based on gestures is described. The method comprises determining a relevant portion of textual information provided on a visual display or other presentation based at least in part on semantic content derived from speech data received from or generated by a speech-to-text module. An annotation based at least in part on gesture data captured by a gesture capture device is generated for display and positioned at the determined relevant portion of the textual information.

### BACKGROUND

The present disclosure relates to systems and methods for providing automatic annotation in media.

### SUMMARY

Providing user input to visual presentations generated by computing equipment may pose technological challenges, including enabling intuitive user input. Various types of user interfaces for receiving user input are known, including keyboards that receive alphanumeric data and microphones that capture user speech that computing equipment can convert to text using natural language processing (NLP) or the like. However, computing equipment often fails to capture and use some intuitive inputs, such as hand gestures, ordinarily used in face-to-face communication or in video conferencing when presenting visual information. Additionally, annotating with devices e.g., touch pad, track pad or other suitable equipment for annotating media, may break the flow of the presentation, cause lag or require irritable amount of time to replace generated annotations either because the gesture is larger than the surface of the input device or the resolution of the input may not match the granularity required for accurate annotation placement.

As a practical matter, computing equipment, such as a keyboard, trackpad, or mouse, may be unavailable to a presenter or to participants when visual information is presented to a group of people, for example, in a live meeting. Thus, the visual presentation provided by the computing device may be insulated from the insights or other real-time input from a presenter or participants.

In some approaches, cameras have been used to capture user gestures, for example, gestures to indicate approval or disapproval of information being presented in an audio-visual display, such as video content. In other approaches, a user in a video conference may raise an arm, which may be detected by a system and signaled to a presenter. However, using such an approach, the system fails to match the raised hand signal to any portion of the presentation or other communication. More generally, such approaches do not enable relating hand gestures to any specific portion of the visual information being presented on a monitor or other display device and do not enable annotating portions of the visual presentation.

A related technological problem is that computing equipment often fails to capture and use for visual presentations words or other alphanumeric information “written” by a user waving a finger or hand freely in the air. Such information may thus be lost when computing equipment presents visual information.

In some approaches, a stylus may be held by a presenter to select a portion of a monitor displaying visual information. In response to the motion of the stylus, a system may highlight or enlarge the selected portion. However, such approaches the system may fail to enable modification of information presented in the presentation and may fail to annotate the presentation based on the stylus motion. In some embodiments, the presenter may use a 2D stylus (e.g., touch pad or other suitable device) to annotate information.

A technological solution is a system that receives speech data, for example, generated by a speech-to-text module and uses semantic content in the speech data to determine a relevant portion of the visual data that is displayed. The system also receives gesture data, such as, for example, a gesture data indicating a circle freely drawn in the air by a user's finger captured by a handheld stylus with an inertial measurement unit (IMU) or captured by a camera. Using the gesture data thus received, the system may select a predetermined graphic corresponding to the gesture data and may generate an annotation of the relevant portion of the visual data determined based on the semantic content of the speech data.

In some embodiments, words or other alphanumeric information written by a user waving a finger or hand freely in the air may be similarly captured and transcribed as alphanumeric information. The transcribed alphanumeric information may be added to annotate the portion of the visual data determined as relevant based on the semantic content. The annotation may modify or correct the text. For example, the system may interpret one or more hand gestures in combination with the transcribed alphanumeric information to mean that the transcribed alphanumeric information is to replace the relevant portion.

The visual presentation may be a live meeting in which a slide or video presentation software is used, a conference conducted via a live video feed, broadcast or transmission from a presenter to a group of participants. The visual presentation may be conducted live with real-time annotations, the annotations may be added after a live presentation of visual information, and/or the visual presentation may be annotated and transmitted at a later time.

In some embodiments, some participants may receive a version of the predetermined graphic based on user profile information. For example, a participant may prefer that on her device information that is to be emphasized (e.g., in response to a circular gesture by the presenter) be encircled in red, while another participant may prefer that on his device information that is to be emphasized be shown using another color or that the letters turn a different color instead of, or in addition to, being encircled.

In some embodiments, some participants may prefer that some types of annotations not be shown on their devices, or that no annotations be shown on their devices. In some embodiments, some participants may prefer annotations of some users and select specific user's annotations to be shown and/or select specific user's annotation to not be shown on their respective devices.

The disclosed system and methods may help address annotation placement on digital files (e.g., videos, slides, static images, live broadcasting and/or any suitable digital environment to place annotations). In some embodiments, the disclosed systems and methods includes determining a relevant portion of textual information provided in a visual display, where the relevant portion of the textual information is determined based at least in part on semantic content comprised in speech data received from a speech-to-text module. The method may further include, selecting an annotation based at least in part on gesture data generated by a gesture capture device and generating for display the annotation at the determined relevant portion of the textual information.

In some embodiments, the method further includes, generating for display the annotation performed as part of a live video conference and the speech data and gesture data are received during the live video conference.

In some embodiments, determining the relevant portion of the textual information comprises determining, based on the semantic content comprised in the speech data, a first relevant portion of the textual information and a second relevant portion of the textual information, and wherein the annotation comprises generating a visual indication of a relationship between the first relevant portion and the second relevant portion.

In some embodiments, the gesture capture device generates gesture data based at least in part on an inertial measurement unit (IMU) sensor.

In some embodiments, the method further comprises determining based at least in part on the gesture data that the textual information is to be modified according to the speech data, where the generating for display the annotation comprises at least one of striking through or removing alphanumeric information.

In some embodiments, the method further comprises receiving gesture data indicating alphanumeric information generated based at least in part on captured human hand movement simulating writing and modifying the determined relevant portion of the textual information based at least in part on the indicated alphanumeric information.

In some embodiments, the gesture data and the speech data are received while the textual information is being displayed.

In some embodiments, the annotation is displayed as part of a video.

In some embodiments, the method further comprises retrieving a user preference from a preference profile and generating for display the annotation comprising a version of the annotation, wherein the version of the annotation is selected based at least in part on the preference profile.

In some embodiments, the method further comprises generating the textual information for display by a user device without the annotation simultaneously with the generating for display the annotation by a second device.

In some embodiments, selecting the annotation based at least in part on the gesture data generated by a gesture capture device comprises, selecting as the annotation a graphical indication from a plurality of predetermined graphical indications.

In some embodiments, the relevant portion of the textual information is determined by identifying a match between speech data and the textual information.

In another approach, the method comprises receiving presentation data for a visual display, receiving speech data captured via a speech-to-text module, receiving gesture data captured via a gesture capture device, determining a correspondence between at least one semantic term identified based on the speech data and semantic content identified in the presentation data, and determining an annotation based at least in part on the received gesture data. The method further comprises generating for display the annotation where the annotation is positioned on the visual display based at least in part on the determined correspondence.

In some embodiments, the method further comprises decoding at least one frame of the plurality of frames of the presentation data and processing the at least one frame of the plurality of frames to identify the semantic content in the presentation data.

In some embodiments, the semantic content identified in the presentation data is first semantic content, and the method further comprises determining a saliency of second semantic content of the presentation data and generating for display a second annotation positioned on the visual display at the second semantic content.

In some embodiments, the semantic content identified in the presentation data is determined based at least in part on user profile data accessed in a database.

In some embodiments, the semantic content identified in the presentation data is determined based at least in part on user selection from multiple candidates. In some embodiments, the received speech data captured via the speech-to-text module is parsed and transmitted to a natural language module to semantically tag and identify parts of speech. In some embodiments, the gesture capture device is a camera, and the gesture data is generated based at least in part on a plurality of images captured by the camera.

In some embodiments, the camera is a LiDAR camera. In some embodiments, the annotation is determined based at least in part on a trace in a 2D plane of a user gesture represented in the received gesture data.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1-3 illustrate sample use cases, according to examples of an aspect of some embodiments of the present disclosure;

FIG. 4 depicts system architecture for annotating a screen share, according to an example of an aspect of some embodiments of the present disclosure;

FIG. 5 illustrates gesture recognition applications, according to an example of an aspect of some embodiments of the present disclosure;

FIG. 6 depicts system architecture for participant annotation of a screen share, according to an example of an aspect of some embodiments of the present disclosure;

FIG. 7 is a flowchart for identifying annotation candidates and finding one or more matches based on speech analysis and visual screen share analysis, according to an example of an aspect of some embodiments of the present disclosure;

FIG. 8 is a flowchart illustrating processing when an annotation candidate applies to a single entity, according to an example of an aspect of some embodiments of the present disclosure;

FIG. 9 is a flowchart illustrating processing for annotations of the type that apply to multiple entities, according to an example of an aspect of some embodiments of the present disclosure;

FIG. 10 is a flowchart illustrating textual annotation processing, according to an example of an aspect of some embodiments of the present disclosure;

FIGS. 11A-11C illustrate black space determination with various saliency thresholds, according to examples of an aspect of some embodiments of the present disclosure;

FIGS. 12A-12B illustrate a process for determining connector shape between two entities to minimize occlusion, according to examples of an aspect of some embodiments of the present disclosure;

FIG. 13 is a flowchart of a process for augmented content generation, according to an example of an aspect of some embodiments of the present disclosure;

FIG. 14 is a flowchart illustrating a process for triggering mechanisms that annotate when automatic/default annotation mode is enabled, according to an example of an aspect of some embodiments of the present disclosure;

FIGS. 15A-15B depict graphical examples of use cases, according to examples of an aspect of some embodiments of the present disclosure;

FIGS. 16-17 are block diagrams of an illustrative user equipment device and system, according to examples of an aspect of some embodiments of the present disclosure;

FIG. 18 is a flowchart illustrating a process for automating annotation of presentation content, according to an example of an aspect of some embodiments of the present disclosure.

The figures herein depict various embodiments of the disclosure for purposes of illustration only. It will be appreciated that additional or alternative structures, assemblies, systems, and methods may be implemented within the principles set out by the present disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

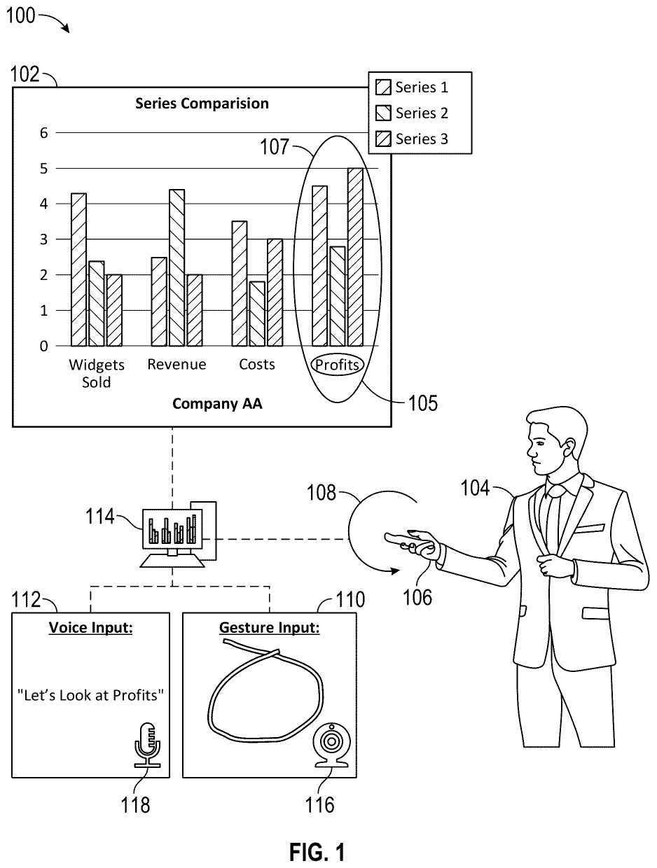

FIG. 1 illustrates a use case of a system 100 for providing voice-driven annotations to media 102 (e.g., a 2D screen share, a video conference, live presentation using a presentation application or video, sportscasting or other broadcasting or transmission, or the like), in accordance with some embodiments of this disclosure. As shown in FIG. 1, the system 100 may provide for automatically placing a closed loop graphic 105 (e.g., circle, box, triangle or any suitable graphic thereof) on text or other information presented based on gesture input 110.

For example, as illustrated in FIG. 1, the presenter 104 may desire to highlight the word “Profits” on a screen share (e.g., media 102). Therefore, the presenter 104 may activate a stylus 106, communicatively coupled to system 100 (e.g., Bluetooth, near-field communication (NFC), wired connection, or any suitable connection method), and perform a closed-loop gesture 108. In some embodiments, the system 100 comprises a gesture analyzer that receives, records and analyzes the closed-loop gesture 108 in order to develop one or more recognizable annotation candidates/graphics (e.g., closed loop graphic 105).

In some embodiments, the stylus 106 comprises an inertial measurement unit (IMU) sensor that records motion data corresponding to the user's hand or arm movements. The IMU data may be processed in real time to identify specific gesture patterns. In some embodiments, the IMU sensor may comprise accelerometers, gyroscopes, and magnetometers. In some embodiments, recorded IMU data may be processed in real time by a gesture analyzer. The gesture analyzer may leverage gesture-recognition algorithms or machine learning models to identify specific user-performed gesture patterns, such as circular motions, swipes, or other predefined movements. In some embodiments, upon detecting a recognized gesture pattern, the system may trigger context-specific interactions, annotations, or commands within the computing environment of system 100. In some embodiments, media 102 may be understood as a visual (e.g., presenting, broadcasting, or streaming).

In some embodiments, system 100 comprises a speech analyzer that receives, records and analyzes speech and/or utterances of the user 104. For example, in FIG. 1, the user 104 utters, “Let's look at profits,” which is received by a sound recording device 118 of the system (e.g., personal device's integrated microphone, external microphone, integrated microphone on the stylus 106, or any suitable sound recording device). In some embodiments, the speech/utterance may be received, decoded and parsed by a speech analyzer. Based on the system 100 detecting the word “profits” and determining a match between speech and media, the system 100 may apply the graphic selected based on the gesture 108 to the corresponding portion of the media 102 based on the determined matching.

In some embodiments, the system 100 determines an intent to highlight and/or to annotate an area of the media 102 by identifying a match between the voice input 112 and the media 102. In the example illustrated by FIG. 1, the system 100 identifies a match between the voice input 112 (e.g., “profits”) and media 102 (e.g., Profits).

In some embodiments, the system 100 identifies a gesture 108 by a device 106 (e.g., a 3D stylus, extended reality (XR) controller, or other similar gesture-capturing devices) to simulate a gesture in 3D free space.

In some embodiments, detecting a generation of a gesture 108, or a termination of a gesture 108 on the stylus 106, may trigger analysis of transcribed speech within a context time window to relate an annotation based on the gesture input to semantic data determined in the transcribed speech. The context time window (e.g., 1-5 seconds, or 0.1-90 seconds, or any suitable amount of time) before or after the captured gesture.

In some embodiments, gesture analysis may be triggered if the system first receives user interface input requesting activation of a gesture input mode. The user 104 may activate gesture mode, for example, on the stylus 106 or by a speech input activating gesture mode. In some embodiments, gesture analysis may be automatically triggered without the user 104 activating the gesture mode as a separate action. In some embodiments, a length of the context time window may be set, e.g., 10 seconds before terminating gesture mode, 10 seconds after terminating gesture mode, or 5 seconds before terminating gesture mode plus 5 second after. In some embodiments, the system 100 may determine a time window before terminating gesture mode by collecting and recording historical data (e.g., relative time stamps) on when the user 104 turns on gesture mode, completes a gesture, and turns off gesture mode. For example, the system 100 may record and store the time stamps between turning on the stylus 106, completing a gesture 108 (e.g., recording minimal movement) and terminating gesture mode (e.g., turning off the stylus 106). The system 100 may determine that upon receiving a suitable amount of historical data, a time delay exists between the user 104 completing a gesture 108 and turning off the stylus 106 (e.g., terminating gesture mode); in such cases, based at least in part on the determined time delay, the system 100 may automatically turn off gesture mode.

In some embodiments, gesture analysis may be triggered by a particular movement of the stylus 106 (e.g., swipe movement, or any suitable movement to initiate recording) or by speech utterance (e.g., “Turn on active gesture mode”). In some embodiments, gesture analysis may be triggered by a or any amount of movement detected by the IMU. In some embodiments, a trigger may be any suitable trigger, e.g., snapping fingers, using key words or phrases.

In some embodiments, speech may be analyzed by a speech analyzer using a natural language processor (NLP). The NLP engine may evaluate the time window of speech data identifying relevant keywords or phrases. In some embodiments, speech audio may be transcribed by an automatic speech-recognition (ASR) module and may result in text that may then be processed by an NLP engine.

In some embodiments, the system 100 may continuously store audio and other aspects of the presentation (e.g., particular video conferencing session) while the session is active. The system 100 may store a presentation, including the media being presented, a presenter's and/or participants transcribed verbal presentation and/or audio presentation, as well as annotations 105, 107 made by the system 100 to the media 102 in response to user gesture data 110 received. In some embodiments, storing a presentation may include recording specific placements of annotation graphics 105, 107 (e.g., highlights, strikethroughs, closed-loop annotations) associated with the media content 102. Such annotations may be stored with or without time stamps, and may indicate what words, phrases or other piece or pieces of verbal information received from the presenter 104 and/or one or more participants enabled the system 100 to correlate the received gesture data to the specific portion of the media content 102. In some examples, the screen share may be a document or slide and may associate annotations with slide number, page numbers or content type (e.g., text, chart, image object, or any suitable file type).

In some embodiments, system 100 comprises a video analyzer that receives, records and analyzes media 102 (e.g., screen share). In some embodiments, the screen share 102 may be analyzed by techniques known in the art. Some examples include optical character recognition (OCR) (to identify words) followed by NLP (context analysis, theme extraction, facet extraction, etc.) and optionally followed by spatial analysis (e.g., for visual content analysis). In some embodiments, OCR may be used to extract textual data from the screen share. The extracted text may be then subject to NLP techniques such as context recognition, theme identification, and facet extraction to determine semantic meaning and salient topics. In some embodiments, a spatial analysis engine may be further employed to analyze positional and relational aspects of the visual elements (e.g., proximity, grouping, layout hierarchies). For example, subsequent to determining that “Profits” is to be annotated, the system 100 may use the spatial analysis engine to further determine that substantially close metadata (e.g., graph corresponding to profits—immediately adjacent) is also to be annotated applying a second annotation 107, which may be understood as a secondary annotation 107. The system 100 may be triggered to insert a secondary annotation due to receiving a second gesture 108, or by identifying key phrases or words in the voice input 112.

In some instances, receiving a special gesture 108 (e.g., large circular motion), which may be a second gesture signaled shortly after the first gesture, or may be a single gesture different from a gesture indicating emphasis on the specific term (e.g., a small to midsize circular gesture that may be interpreted as emphasizing just the term “Profit”) may cause the first annotation 105 to expand into the second annotation 107. In some embodiments, the system 100 may decide to insert a secondary annotation 107 based on speech context (e.g., voice input 112). For example, if the word “Profit” is repeatedly emphasized throughout a presentation, or if the gesture input 110 is repeatedly received for the term “Profit” throughout the presentation, then the system 100 may determine that the secondary annotation 107 is to be added for related words or graphics associated with term “Profit.” The secondary annotation 107 may be a different color or may be otherwise shown as different from the primary annotation 105. For example, the secondary annotation 107 may be a different shape or may have a different thickness than the primary annotation 105.

In some embodiments, the system 100 includes a feature for spatial analysis. For example, one or more techniques from the spatial analysis domain may be employed to determine relationships in media 102. In FIG. 1, a circular highlight may be applied to “Profits,” but when a spatial analyzer is employed, the spatial analyzer may determine that adjacent elements on media 102 are to be annotated (e.g., bar graph over “Profits”). Some techniques may include variogram analysis, texture quantification, deep learning methods and techniques, spatial gradient measurements or any other suitable spatial analysis techniques for image recognition.

In some embodiments, the circular movement 108 of the gesture device 106 and the utterance may be captured by a respective device (e.g., microphone 118, gesture device 106, camera 116). In some embodiments, the respective device (e.g., microphone 118, gesture device 106, camera 116) may be integrated with a user device 114. The user device 114 may be any suitable device (e.g., personal computer, smartphone, gaming console, extended reality headset, smart television, etc.) that has processing capability and connectivity to a communications network that facilitates the implementation of the system 100 sessions for one or more users 104.

In other examples, the screen share 102 may be hosted over a video conference application (e.g., Zoom, Teams, or any other suitable conferencing applications) that has connectivity to a communications network and can facilitate the implementation of the system 100 sessions for one or more users. In some embodiments, the system 100 may apply to other telecasting applications (e.g., sports casting, weather casting or any other suitable telecasting application).

In some embodiments, the NLP uses a large language model (LLM) to perform natural language understanding and contextual inference. For example, the utterance may be received and processed by an LLM (e.g., a transformer-based model such as BERT, GPT, or a fine-tuned domain-specific variant), which performs deep semantic analysis including contextual parsing, named entity recognition, and intent classification. In some embodiments, the LLM determines that the utterance includes a directive intent associated with the visual entity “Profits,” and infers that the word “Profits” may be the likely subject of the present annotation gesture.

The trained ML model, in some instances, may refine gesture-to-content mapping using historical data derived from the user's speech and annotation profile. In one example, the presenter may routinely emphasize financial metrics during presentations, historically annotating terms such as “Profits,” “Revenue,” or “Margins.” The ML model may incorporate this historical behavioral data. When the user 104 subsequently utters a phrase like “Profits have improved,” accompanied by a general-purpose gesture 108 (e.g., circling gesture with no clear spatial reference), the ML model may utilize previously established annotation patterns from the user's profile. Consequently, the system may disambiguate by associating the gesture 108 with the term “Profits” and accurately apply the visual annotation.

The media 102 (e.g., screen share) may be analyzed by a video analyzer module, which applies OCR to extract on-screen text. In this example, extracted textual data may be determined to be semantically aligned with the LLM-derived linguistic features to identify matching entities.

In some embodiments, personal device 114 receives gesture input 110 and voice input 112 and computes and analyzes actions locally, e.g., by the personal device 114. In some embodiments, the personal device 114 receives gesture input 110 and voice input 112 and computes and analyze actions by a remote server/device.

In another example, if multiple instances of the term “Profits” exist within the media content 102, the system 100 may employ a suitable algorithm to disambiguate placement of the annotation 105 in response to the gesture 108. The algorithm may consider factors such as visual saliency (e.g., prominence, font size, contrast, or central positioning within the visual hierarchy) to determine which instance of “Profits” may be most contextually relevant. In some embodiments, the annotation 105 may be applied to more than one, or to all identified matches of content in the media 102.

In some embodiments, a camera 116 coupled to (or integrated with) the computing device 114 captures images or video of the user 104 performing gesture 108. The captured images may be analyzed using image-processing algorithms or machine learning techniques that identify specific gesture 108 or movements of the user's hand, stylus, or body. In some instances, upon recognizing a particular gesture pattern 108—such as drawing a circle or outlining an object—the system 100 may translate the gesture 108 into a corresponding shape or graphical annotation 105 (e.g., difference between circle in gesture input 110 and annotation 105). The generated shape may be automatically overlaid onto displayed media 102.

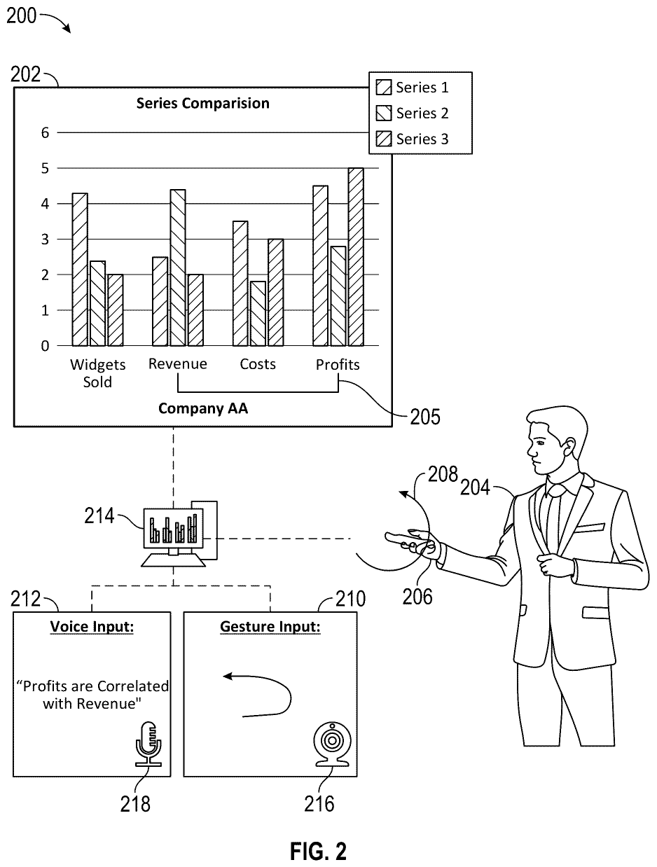

In some embodiments, the gesture analyzer includes an image processing module. For example, image data of the presenter's movements may be captured by a camera 116 and sent to the gesture analyzer. The gesture analyzer may then process the received images through various methods. In some examples, any analyzer described herein may use data derived from simultaneous localization and mapping (SLAM), and/or LiDAR to form or place annotations. In some embodiments, 2D or 3D imaging techniques may be used to derive the annotation, or direct sensory measurement from a user-handled device via an IMU may be used FIG. 2 illustrates a use case of a system 200 for providing voice-driven annotations to media 202 (e.g., 2D screen share, video conference, sportscast or similar presentation), in accordance with some embodiments of this disclosure. As shown in FIG. 2, the system 200 provides for automatically placing an open loop graphic 205 (e.g., connecting line, connecting line with an arrow or any suitable graphic thereof) by receiving at least one of a voice input 212, gesture input 210, and media input 202. In some embodiments, the system 200 and methods described herein may be similar to the system 100 illustrated in FIG. 1.

System 200 may provide voice-driven annotations to media 202, specifically to correlate one element of media 202 to another. The components listed and depicted in FIG. 2 may be similar or have the same or similar features as the components described above, and therefore the description of similar features is omitted for brevity (e.g., 102 may be the same as or similar to 202, 104 may be the same as or similar to 204, etc.).

In this example, the system 200 receives from presenter 204 voice input 212 e.g., “Profits are correlated with revenue.” The system 200 analyzes this voice input 212 and identifies two distinct semantic matches within the displayed media 202: specifically, the terms “Profits” and “Revenue,” each appearing as single instances in the displayed media 202. Concurrently, or shortly before or after the receipt of the voice input 212, the presenter 204 performs a gesture 208 representing an arrow shape using a stylus 206. In some embodiments, based on contextual analysis of the spoken content, the system 200 may determine that the intended arrow gesture 208 is meant to visually link two identified semantic matches, e.g., “Profits” and “Revenue.” Further, based on the context of the user's 204 previously stored presentation content 202, previously stored content items associated with the presenter 204, presentation content received from one or more of the participants, previously stored content items associated with one or more of the participants, and/or ML techniques for interpreting and contextualizing the received voice input 212, the system 200 may determine that the arrow 208 connects the handwritten terms or shapes, and may thus further determine the direction of the arrow to highlight the logical association between the two terms contained in the voice input 212. Accordingly, the system 200 automatically generates an improved graphical representation of the arrow gesture 205, free from imperfections inherent in manual drawing.

In this example, to precisely determine the annotation direction based on the spoken statement “Profits are correlated with revenue,” the system 200 may utilize advanced NLP techniques involving semantic parsing and LLMs. First, speech-to-text transcription converts spoken words into textual input. Next, the transcribed text undergoes parsing and syntactic dependency analysis, identifying the grammatical relationships among words (e.g., subject, object, predicate). Specifically, dependency parsing identifies “Profits” as the subject and “revenue” as the object of the relational predicate “are correlated with,” implicitly establishing a directional or causal link.

In this example, semantic role labeling (SRL) further assigns clear thematic roles: in this example, labeling “profits” as the dependent or outcome entity and “revenue” as the influencing or predictor entity. Moreover, employing LLMs (such as GPT or transformer-based models) can enhance context awareness, understanding nuanced phrases or implied causal directionality embedded in natural language speech.

Once the semantic directionality between entities may be established—here, that “profits” may be dependent on or predicted by “revenue”—the system explicitly translates this relationship into a visual annotation instruction. Consequently, an arrow annotation may be algorithmically drawn from “Revenue” (the influencing term) toward “Profits” (the dependent term), reflecting the semantic interpretation derived from the speaker's 204 statement.

In some embodiments, the system 200 may utilize one or more methods to optimize placement of graphical annotations (e.g., arrow 205) and avoid occluding words or images in the media. Some examples include: visual saliency mapping, text and object detection, geometric optimization algorithms, ML and LLM contextual guidance, collision detection and iterative adjustment or any suitable algorithm thereof.

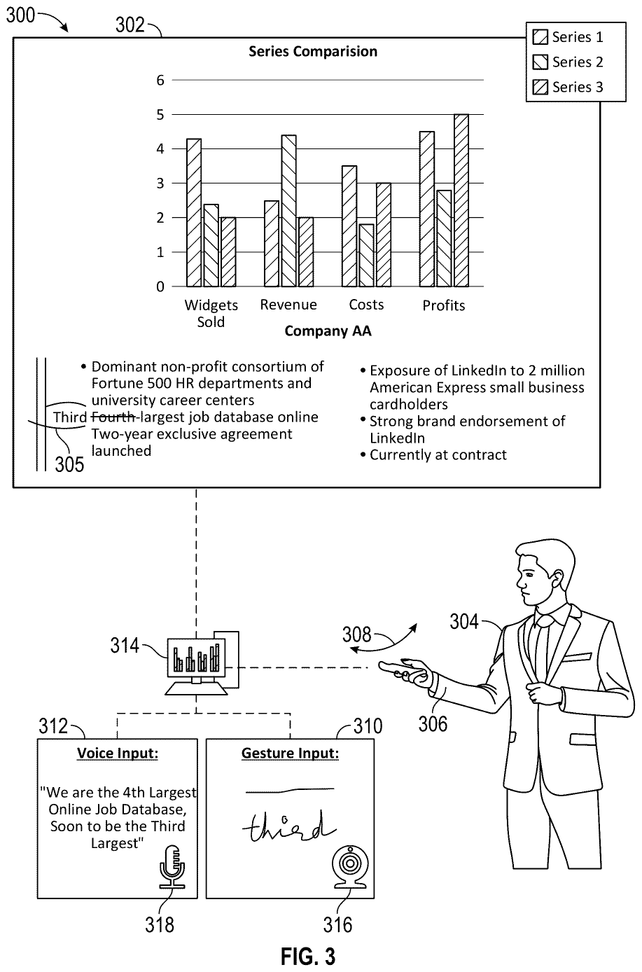

FIG. 3 illustrates a use case of a system 300 for providing voice-driven annotations to media 302 (e.g., 2D screen share, video conference, sportscasting or other presentation), in accordance with some embodiments of this disclosure. As shown in FIG. 3, the system 300 provides for automatically placing an open loop graphic 305 (e.g., a strikethrough, a word insert or any suitable graphic thereof) by receiving at least one of a voice input 312, gesture input 310, and media input 302. In some embodiments, the system 300 and methods described herein may be similar to the system 100 illustrated in FIG. 1.

Building upon FIGS. 1-2, system 300 may be implemented to provide voice-driven annotations to media input 302, specifically to edit elements of media input 302. The components listed and depicted in FIG. 3 may have the same or similar features as the components described above, and therefore the description of similar features is omitted for brevity (e.g., 102 may be the same as or similar to 302, 104 may be the same or similar to 304, etc.).

In this example, the presenter 304 verbally states, “We are the 4th largest online job database, soon to be the third largest.” Concurrently, the system 300 captures two sequential free-space gestures from the presenter via gesture input 310 using the IMU-equipped stylus 306. In some embodiments, the first gesture may be recognized as a short linear stroke, followed immediately by a second gesture identified as the handwritten word “third.” The system 300 utilizes integrated speech-to-text processing and visual analysis algorithms to correlate these inputs (e.g., via a speech analyzer, a video analyzer and a gesture analyzer).

In some embodiments, the second gesture 308 may be received by the system 300 from the same device 306 as the first gesture. In other embodiments, the second gesture 308 may be written on a surface (e.g., touch pad) using a finger(s) of the presenter 304.

In some embodiments, the system 300 identifies a single semantic match between the presented media content 302 and voice input 312, e.g., “Fourth-largest.” Upon determining a single match, the system 300 may logically exclude possible meanings of the linear stroke gesture. Consequently, the system 300 may narrow the interpretative possibilities to annotations, e.g., an underscore or a strike through.

In some embodiments, not depicted in FIG. 3, the system 300 may use the raw gesture input 310 (e.g., handwritten gesture input 310) as the annotation candidate 305 instead of interpreting the gesture 308 as a shape or graphical annotation candidate 305.

In some examples, the subsequent handwritten gesture of the word “third” introduces ambiguity: the system 300 must ascertain whether “third” applies independently or contextually links the existing textual entity. To resolve this ambiguity, the system 300 may derive additional semantic context from the spoken phrase “soon to be third-largest” using NLP techniques, such as facet extraction via subject-verb-object (SVO) parsing. In this example, NLP analysis may identify a direct semantic relationship between the object “third largest” and the subject entity “fourth-largest job database online.” Advanced NLP frameworks, including transformer-based models such as bidirectional encoders (e.g., BERT), can also be employed to robustly confirm this attribution.

Continuing the example, facet extraction may be utilized to find SVO parsing. For example, <4th largest Online database>—<soon to be>—<3rd largest> may be understood as 3rd largest (object) applying to 4th largest online database (subject). Therefore, the system 300 may interpret the initial linear stroke as a strike through gesture specifically applied to the word “fourth” in the matched entity. The handwritten word “third” 310 recognized from the subsequent gesture 308 may be then visually rendered next to the strike through, precisely font-matched and contextually aligned with the original media text. This graphical annotation 305 may be considered a specialized form of connector, linking the semantic transition from “fourth” to “third.”

In some examples, the presenter 304 may input the annotation term “third” 310 through various modalities beyond free-space air-writing gestures. For instance, the term may be provided verbally as a spoken utterance, whereby the speech analyzer utilizes speech-to-text transcription and NLP-based semantic inference to identify and extract the intended annotation term. In a particular example, the system 300 may identify categories of terms to identify whether a term on the screen share 302 should be replaced. Continuing the example, illustrated in FIG. 3, the utterance “third” 312 may be categorized as a placement term; the term “fourth” as found on the screen share 302 may also be categorized as another placement term, and since the terms match in categories but are different in meaning, the placement of the “third” graphic/annotation may be overlapped or placed adjacent to the term “fourth.”

In some embodiments, the correction and/or annotation of the screen share 302 may be done automatically, that is, without additional permission from the presenter 304. In some embodiments, the presenter 304 may be shown a preview on a personal device 314 or on the screen share 302 itself of the annotation 305 and request that the presenter confirm the annotation 305 and placement of said annotation 305 before the system 300 applies it.

In other embodiments, the presenter 304 may physically write the term “third” on a surface, such as paper or a desktop, using a stylus 306 or pen configured with motion-capture sensors (e.g., an IMU-equipped stylus). In such cases, handwriting recognition algorithms process the sensor-derived motion data, converting handwritten gestures into textual annotations. Additionally, conventional input methods such as keyboard entry or touchscreen interaction may also be employed, allowing direct textual input of the term “third.”

In the event that the system identifies two gestures (e.g., one derived from a stylus and one derived by any of the other modalities described herein), the system may correlate one of the gestures (e.g., line) to a second gesture (e.g., “third”).

In some embodiments, multiple and different users of the system 300 may add a respective annotation candidate 305 to the screen share 302. As illustrated in FIG. 3, the line may have been input by a participant while the term “third” may be recorded by the presenter 304, or vice versa.

The presenter 304 may want to edit the screen share 302 in real time, therefore, instead of a strikethrough, the line may represent removing a word altogether and inserting a subsequent recorded gesture input 310.

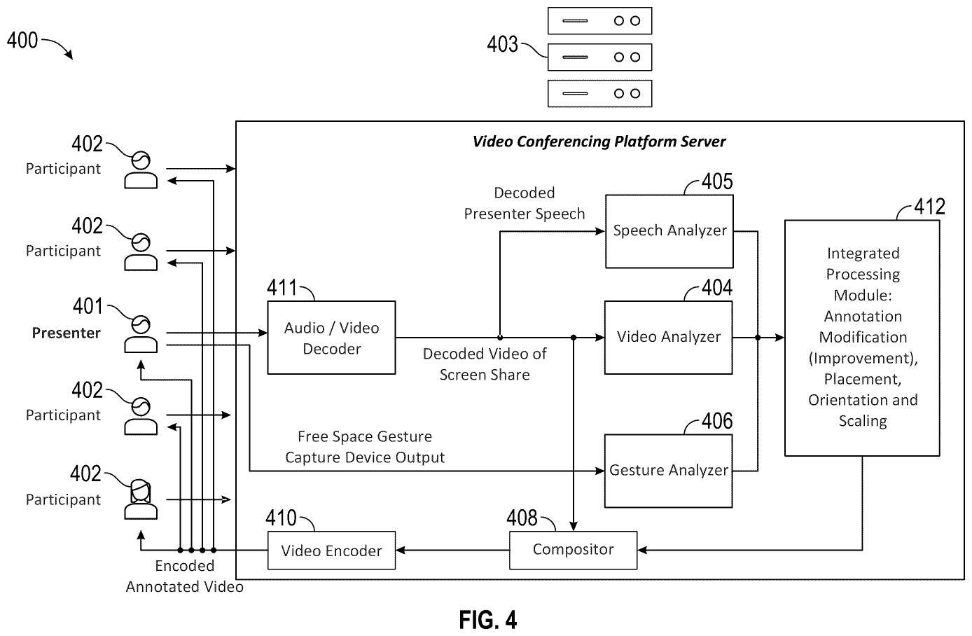

FIG. 4 illustrates the system architecture for system 400, provided on a video conferencing platform 403, in accordance with some embodiments of this disclosure. As shown in FIGS. 1-3, the system 400 provides for automatically placing an annotation by receiving at least one of a voice input, gesture input, and media input. In some embodiments, the system 400 and methods described herein may be the same as or similar to the system 100 illustrated in FIG. 1.

Building upon FIGS. 1-3, system 400 may be implemented on a video conferencing platform server 403, comprising several modules (e.g., speech analyzer 405, video analyzer 404, gesture analyzer 406, video encoder 410, audio/video decoder 411, and an integrated processing module 412) to provide voice-driven annotations to media. The components listed and depicted in FIG. 4 may be similar to, or have the same or similar features as, the components described above, and therefore the description of similar features is omitted for brevity.

In some embodiments, the system 400 may provide face-to-face communication or video conferencing when presenting visual information. During face-to-face communication or video conferencing scenarios involving visual information sharing, presenter audio and shared visual content (screen share) are decoded by the video conferencing platform 403. Decoded audio may be processed by the speech analyzer 405, while decoded video content may be directed to the video analyzer 404. The speech analyzer 405 may utilize NLP techniques, including context analysis, theme and facet extraction, named entity recognition, and semantic correlation, to establish context, resolve ambiguities in gestures, identify matches between spoken words and visual content, and determine the orientation or positioning of annotations such as arrows or connectors.

In some embodiments, the video analyzer 404 conducts extensive processing, including OCR to extract textual content from the shared screen. In some embodiments, the video analyzer 404 may also apply semantic understanding methods to match speech with textual or graphical content, even when exact textual matches are not present. Further, spatial analysis (e.g., visual saliency ranking) may be utilized to determine the importance of visual entities, resolving ambiguity when multiple visual matches are possible. In some embodiments, the video analyzer 404 may identify visual themes, e.g., fonts and design templates.

In one example, media intended for sharing during a video conference may be pre-uploaded or delivered via an API. The video analyzer 404 may be replaced by a visual analyzer, eliminating per-frame OCR, and instead focusing directly on semantic and spatial analysis based on pre-existing metadata or extracted visual features. Metadata such as font style, layout, and design patterns may either be directly extracted or inferred through machine learning techniques, notably convolutional neural networks (CNNs). In an implementation, a visual analyzer may be used in concert with a video analyzer.

In some embodiments, annotation privileges are extended to other video conference participants (e.g., any of participants 402) with presenter's 401 permission. In such instances, while the media presented may be derived from the original presenter 401, audio and gesture inputs from authorized participants are routed to the speech analyzer 405 and gesture analyzer 406, respectively. The system 400 may dynamically adjust the context and annotation placement based on participant input.

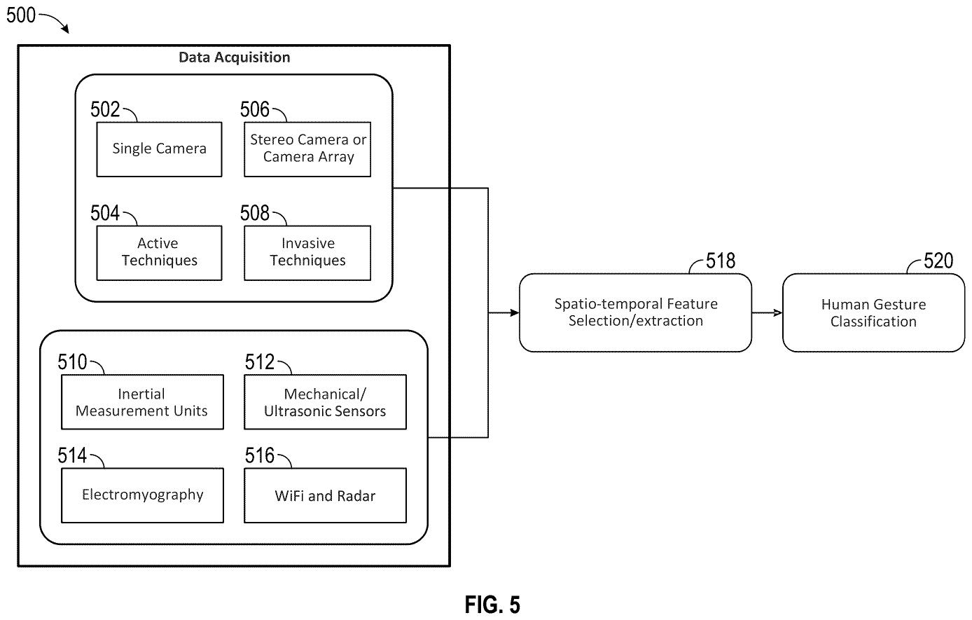

FIG. 5 illustrates gesture data acquisition methods for system 500, to provide for voice-driven annotations in media, in accordance with some embodiments of this disclosure. In some embodiments, the system 500 and methods described herein may be the same as or similar to the systems illustrated in FIGS. 1-4.

Building upon FIGS. 1-4, system 500 may be implemented to providing voice-driven annotations to media, specifically alternative methods for providing gesture recognition. The components listed and depicted in FIG. 5 may have the same or similar features as the components described above, and therefore the description of similar features may be omitted for brevity.

In some embodiments, a free space gesture capture device's output (e.g., 3D stylus, XR controller or any suitable free space gesture capture device) may be directly sent to the gesture analyzer on the video conferencing platform server. Some example methods for gesture acquisition may include single camera 502, stereo camera or camera array 506, active techniques 504 (e.g., active sensing), invasive techniques 508, IMU 510, mechanical/ultrasonic sensors 512, electromyography 514, and/or Wi-Fi and radar 516. One or more of the image data captured by the camera(s), or captured gesture data, captured speech data, may be processed locally or transmitted to a cloud application and processed offsite.

In some embodiments, invasive techniques 508 for gesture recognition may involve placing sensors directly on or inside the body (e.g., user) to detect movements in some instances utilizing methods e.g., surface electromyography (sEMG) or implanted sensors. In some embodiments, non-invasive methods, may be understood as a rely on external sensors or cameras to track movements without physical contact or implantation on organic matter.

Gesture data acquired by any of the methods described herein, may transmit data to spatio-temporal feature selection/extraction 518, located, in some instances, on a video conferencing platform server. Once the gesture data is properly extracted 518, the gesture data may be sent to a human gesture classification module 520 (e.g., module containing the NLP and/or OCR). The human gesture classification module 520 may be a trained ML model that selects an annotation, from two or more annotation candidates, for insertion in the presentation media content by classifying the gesture input data received as being closest to data that is associated with the annotation selected.

In some embodiments, the gesture capture mechanism may also be 2D or 3D imaging based. For example, an appropriately set up video camera may infer the annotation directly from the user's hand/finger movement gesture, or the 2D imaging device may be augmented with depth data (e.g., Leap Motion, Microsoft Kinect, etc.) for a more accurate gesture capture setup.

In some embodiments, another participant in the video conference may make an annotation. In such cases, the screen share delivered to the video analyzer (e.g., video analyzer 404 of FIG. 4) may be derived from the presenter; however, the participant's audio and free space gesture capture may be fed into the speech analyzer (e.g., speech analyzer 405 of FIG. 4) and gesture analyzer (e.g., gesture analyzer 406 of FIG. 4) respectively. Thus, the annotation and the context are derived from the participant, while the annotation may be placed on the screen share by finding a match between the presented visual content and the participant's speech.

In some embodiments, the gesture analyzer involves matching captured gestures against annotation candidates. Gestures may be recognized explicitly or may produce multiple annotation candidates, requiring further contextual disambiguation via speech analysis. Gesture recognition, including handwriting recognition (air-writing), may leverage various input devices, such as 3D styluses, XR controllers, smart wearable devices, and imaging-based systems like Leap Motion or Kinect. Gesture capture mechanisms may remain continuously active or be activated through user interaction (e.g., button press, capacitive touch, wake gestures, or voice commands), depending on system design preferences.

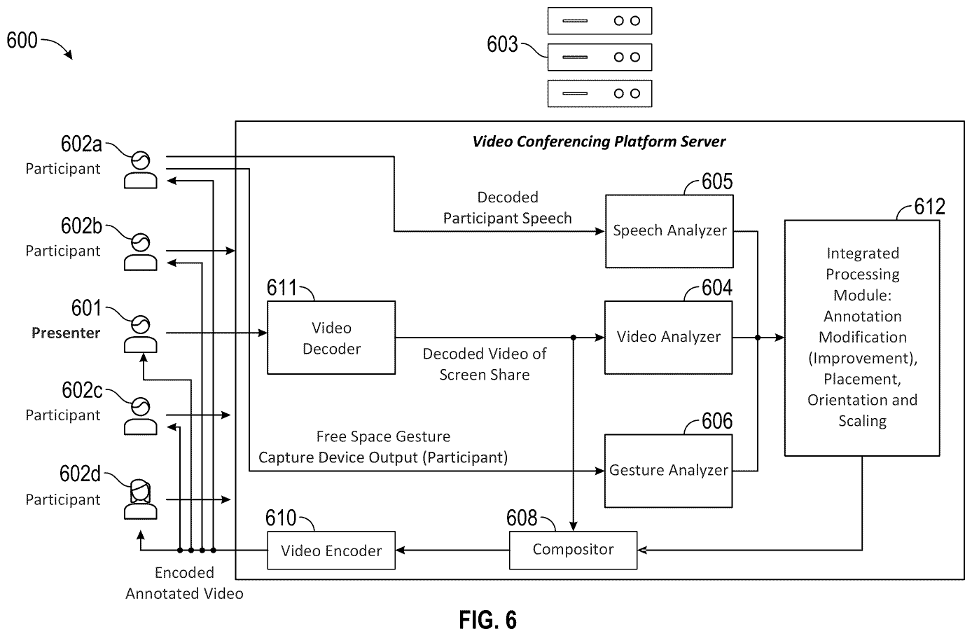

FIG. 6 illustrates the system 600 architecture for participant annotation, in accordance with some embodiments of this disclosure. As shown in FIGS. 1-5, the system 600 provides for automatically placing an annotation by receiving at least one of a voice input, gesture input, and media input. In some embodiments, the systems 600 and method described herein may be the same as or similar to the system 400 illustrated in FIG. 4.

System 600 may be implemented on a video conferencing platform server 603, comprising several modules (e.g., speech analyzer 605, video analyzer 604, gesture analyzer 606, video encoder 610, audio/video decoder 611, and an integrated processing module 612) to provide voice-driven annotations to media. The components listed and depicted in FIG. 6 may be similar to, or have the same or similar features as, the components described above, and therefore the description of similar features may be omitted for brevity.

In some examples, the system 600 may accommodate participants (e.g., participant 602a) to send speech and gestures to a respective speech analyzer 605 and gesture analyzer 606. In some embodiments, the initial presenter may allow participants (e.g., any of participants 602a-602d) to be co-authors/presenters causing the system to analyze the co-authors/presenter's speech and gesture.

In one example, the presenter 601 may be presenting a screen share (e.g., 302 of FIG. 3) and a participant (e.g., 602a) may provide a gesture input to generate an annotation, or to modify and/or improve any annotation that had been generated based on presenter gesture input. In one embodiment, a participant may utter commands to change the style, shape, font, and/or color of an annotation. In some embodiments, a participant may utter commands to move an annotation. In some embodiments, the words and gestures of one or more of the participants may be used to generate annotations in addition to, or instead of, those of the presenter. In some embodiments, some participants may be enabled to provide gesture and/or verbal input as described herein while other participants may not. For example, some participants may be “approved participants,” authorized by the presenter, to provide such input.

In some embodiments, a participant may find some aspects of the presentation particularly useful and may wish to generate annotations only for his or her own version of the presentation without others seeing it. This participant may designate one or more other participants to see such private annotations. This participant may make a hand gesture that may then be used to generate such a private annotation that only that participant would see (e.g., in a video presentation, the annotation would appear only on this participant's monitor). In another example, a participant (e.g., 602a) may provide speech input together with the participant's hand gesture to generate an annotation. A stored version of the presentation that is maintained for this participant may then include this annotation. Conversely, a participant may wish not to see on this participant's own version of the presentation one or more annotations of the presenter. For example, a participant may find the presenter's annotation distracting or irrelevant to the participant's needs. The participant may make a hand gesture, for example, a hand gesture in a reverse direction of the direction that initially generated the annotation (e.g., a counterclockwise circular hand motion if the annotation had been generated by a clockwise circular hand gesture) or may input a command in other ways, to remove or to otherwise modify the annotation. The participant may enter a command to turn off some or all of the presenter's annotations as seen by this participant. A stored version of the presentation that is maintained for this participant may then include the annotation-free version/limited annotation version of the presentation.

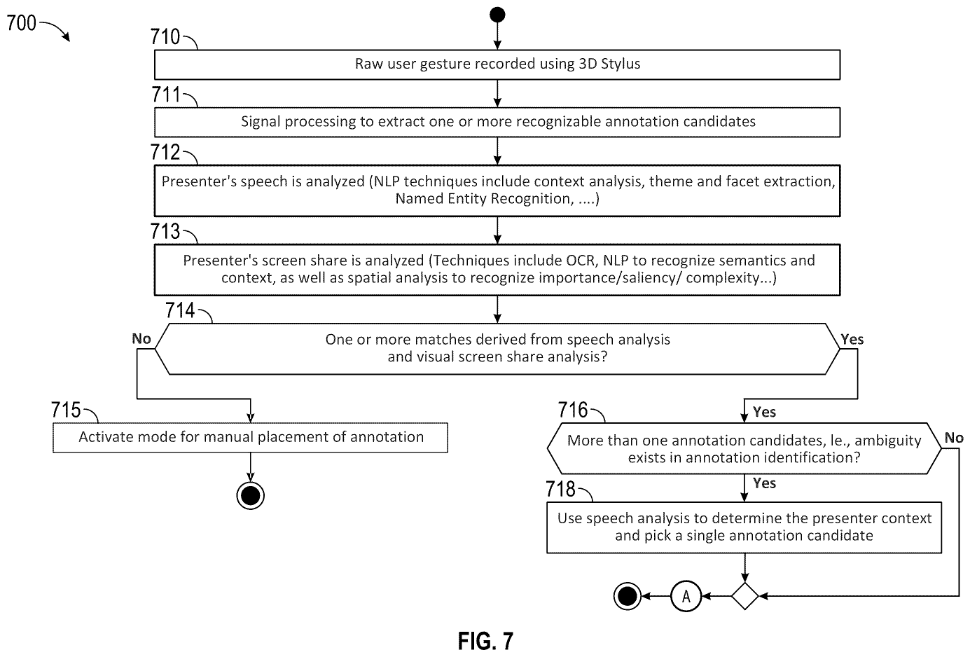

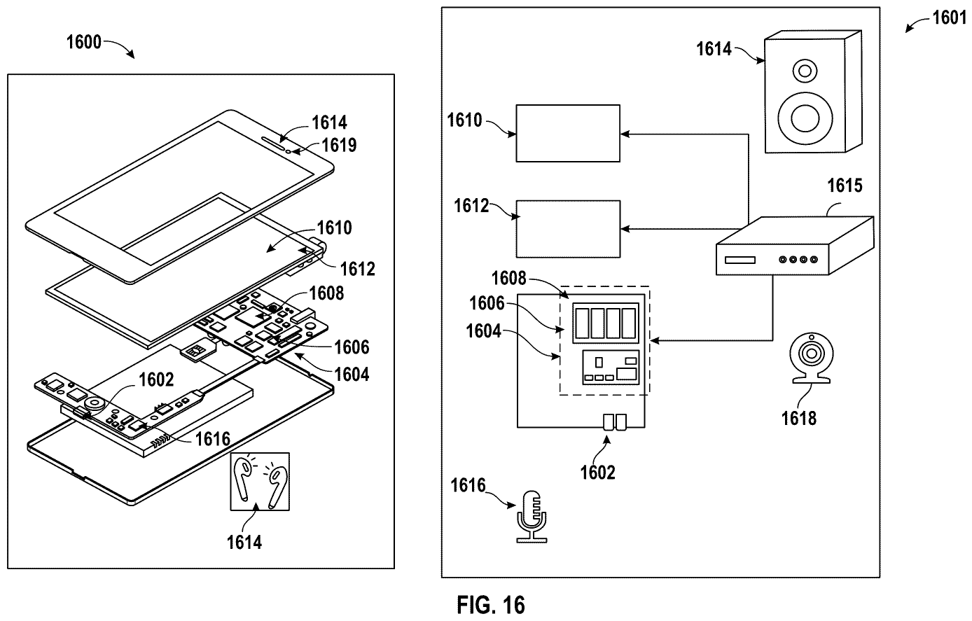

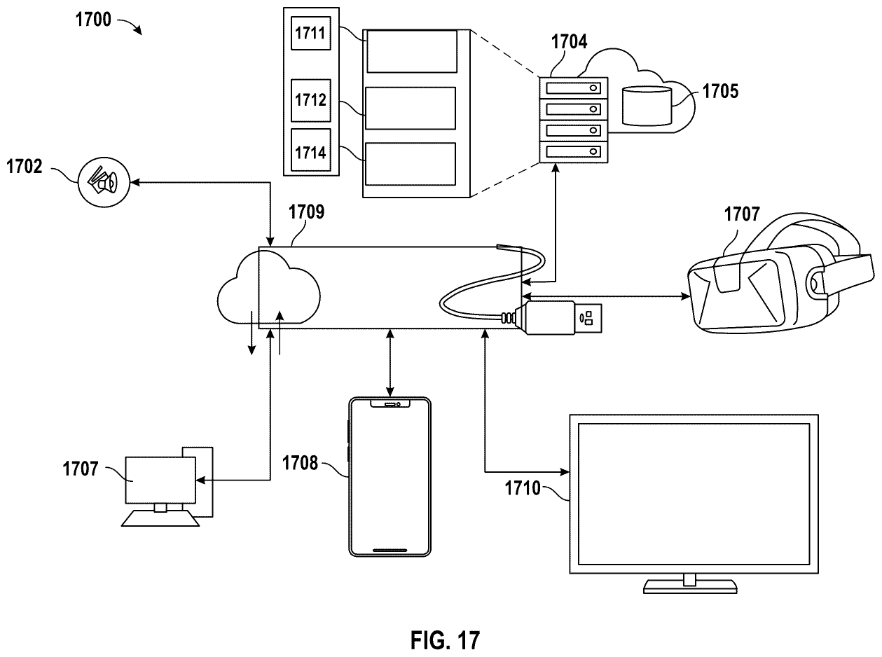

FIG. 7 is a flowchart of a system 700 for identifying single annotation candidates and finding one or more matches between speech analysis and visual screen share analysis, in accordance with some embodiments of this disclosure. One or more actions of the method 700 may be incorporated into or combined with one or more actions of any other process or embodiments described herein. These and other methods described herein, or portions thereof, may be saved to a memory or storage (e.g., of the systems shown in FIG. 16 or 17) or locally as one or more instructions or routines that may be executed by any suitable device or system having access to the memory or storage to implement these methods. As shown in FIGS. 1-6, the system 700 provides for automatically placing an annotation by receiving at least one of a voice input, gesture input, and media input. In some embodiments, the systems 700 and method described herein may be the same or similar to the system 100 illustrated in FIG. 1.

The components listed and depicted in FIG. 7 may be similar have the same or similar features as the components described above, and therefore the description of similar features may be omitted for brevity.

The method begins at step 710, where a gesture may be recorded using a 3D stylus. At step 711, signal processing may be done to extract one or more recognizable annotation candidates. In some embodiments, the method may start when the system provides a media presentation. For example, the system may receive or generate for display content, such as a media presentation (e.g., video stream or broadcast, slides, extended or virtual reality [XR] display, social media feeds, or the like).

At step 712, the presenter's speech may be analyzed with techniques described above (e.g., with NLP, to recognize context analysis, theme and facet extraction, name entity recognition and/or similar methods). It will be understood that the speech data may be received and/or transcribed before, after or contemporaneously with, receipt of the gesture data.

At step 713, textual (e.g., alphanumeric) information and/or graphical or other displayed information of the presenter's screen share is analyzed (e.g., with OCR, NLP and/or similar methods suitable for recognizing semantics). Additionally spatial analysis may be done simultaneously or at different times to evaluate visual saliency of information presented.

At step 714, the system 700 may determine whether one or more textual data or graphical elements of the presentation (e.g., elements on a screen share) match lexical or semantic data (e.g., derived from voice input). If no match is determined, the system 700 may default to step 715, causing the system 700 to activate a mode for manual placement of the annotation. The system may prompt the presenter to position the annotation generated based on the gesture input. For example, the presenter may move the circular annotation to a portion of the presentation content as appropriate in view of the intention of the presenter for the gesture. If a match at step 714 is determined, the system 700 may progress to step 716.

At step 716, the system 700 may determine that there are one or more annotation candidates. If more than one annotation candidate is determined, the system 700 may determine that ambiguity exists. Upon identifying that ambiguity exists, the system 700 may utilize speech analysis to determine the presenter context and pick a single annotation candidate at step 717, or else the system 700 may skip selecting a single annotation candidate and proceed to annotating the screen share as is, at step 719. In other embodiments, the system 700 may include speech from the participants to assist in determining context. The system 700 may prompt the presenter or one or more participants to position the annotation generated. For example, the system 700 may indicate two or more words of the presentation and request manual disambiguation. The presenter or one or more of the participants may select the word to be annotated as appropriate.

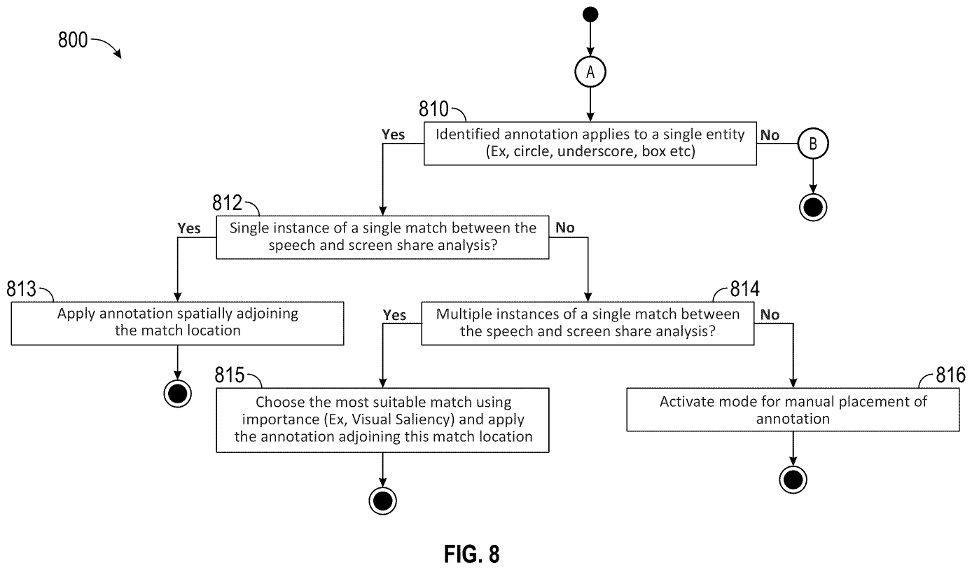

FIG. 8 is a flowchart illustrating a process 800 for determining when identified annotation candidates apply to a single entity or multiple entities, in accordance with some embodiments of this disclosure. One or more actions of the method 800 may be incorporated into or combined with one or more actions of any other process or embodiments described herein. These and other methods described herein, or portions thereof, may be saved to a memory or storage (e.g., of the systems shown in FIG. 16 or 17) or locally as one or more instructions or routines, which may be executed by any suitable device or system having access to the memory or storage to implement these methods. As shown in FIG. 8, the system 800 provides for automatically placing an annotation by receiving at least one of a voice input, gesture input, and media input. In some embodiments, the systems 800 and method described herein may be the same or similar to the system 100 illustrated in FIG. 1.

The components listed and depicted in FIG. 8 may be similar have the same or similar features as the components described above, and therefore the description of similar features may be omitted for brevity.

The process 800 begins with determining, at 810, whether the identified annotation applies to at least one entity (e.g., circle underscore or similar graphic is relevant to a specific word of the presentation). If at least one entity is identified at 810, then the system 800, at step 812, determines whether there exists a single instance of a single match between the speech and screen share. If a single match is identified, the system 800 applies an annotation spatially adjoining the match location, at step 813.

If multiple matches are determined/identified, at step 814, the system 800 chooses the most suitable match using an importance algorithm (e.g., visual saliency) and applies the annotation adjoining this match location 815.

If multiple matches are not determined/identified, at step 814, the system 800 cannot resolve to which entity the annotation is to be applied, then the system 800 may activate a mode for manual placement of annotation, at step 816.

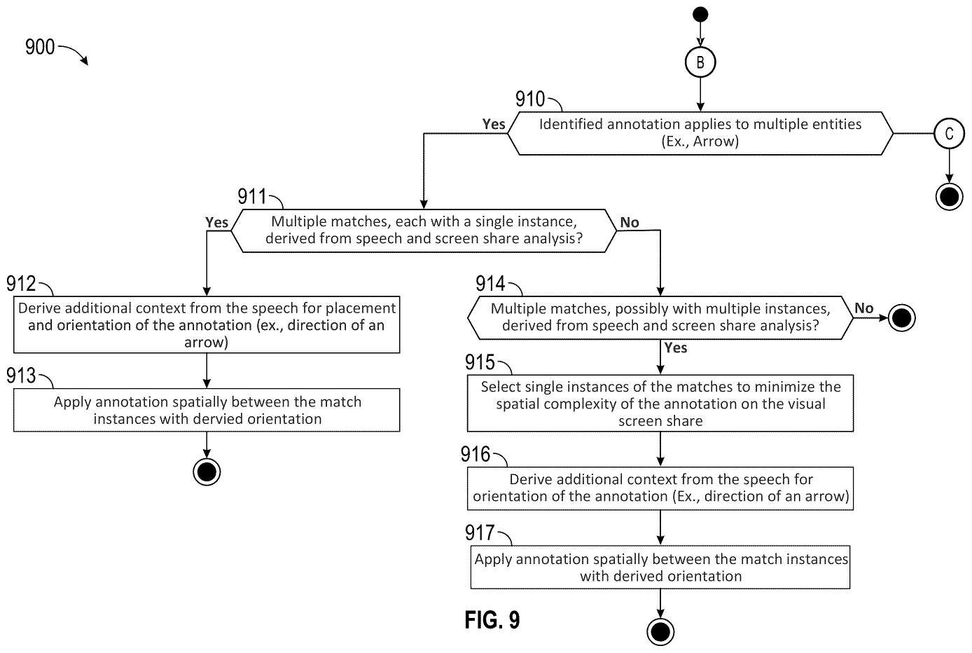

FIG. 9 is a flowchart of a process 900 configured to resolve annotation candidates that match multiple target entities, in accordance with some embodiments of this disclosure. One or more actions of the method 900 may be incorporated into or combined with one or more actions of any other process or embodiments described herein. These and other methods described herein, or portions thereof, may be saved to a memory or storage (e.g., of the systems shown in FIG. 16 or 17) or locally as one or more instructions or routines, which may be executed by any suitable device or system having access to the memory or storage to implement these methods. As shown in FIG. 9, process 900 provides for automatically placing an annotation by receiving at least one of a voice input, gesture input, and media input. In some embodiments, the process 900 may be used with examples illustrated in FIGS. 1-3.

The components listed and depicted in FIG. 9 may be similar have the same or similar features as the components described above, and therefore the description of similar features may be omitted for brevity.

The method begins at step 910, at which the system 900 may determine whether an identified annotation (e.g., arrow, connector or similar annotative graphic) applies to multiple entities shown in the presentation. If the system 900 determines that one annotative graphic applies to multiple entities, the method continues to step 911: determining whether there are multiple matches for the annotation, each with a single instance, derived from speech and screen share analysis.

If the system 900 determines that multiple matches do exist, the system, at step 912, may derive additional context (e.g., metadata) from the speech for placement and orientation of the annotation (e.g., direction of the arrow). Upon deriving additional content, the system 900, at step 913, applies the annotation spatially between the matched instances with an orientation derived from the speech data.

On the other hand, at step 911, the system 900 may determine that there are multiple matches for the annotation that each may involve two or more instances. The system 900 then determines, at step 914, whether multiple matches, with multiple instances, derived from speech and screen share analysis, exist.

At step 915, if the system 900 determines that multiple matches with multiple instances exist, then the system may select for the placement of the annotation single instances of the matches to minimize the spatial complexity of the annotation on the visual screen share. For example, a pair of items to be connected by the annotation may be selected to avoid or to minimize having to generate a line as part of the annotation that traverses words or important graphics of the presentation.

At step 916, the system may derive additional context from the speech for orientation of the annotation (e.g., direction of an arrow). Once the system derives additional context, the system, at step 917, may apply the annotation spatially between the match instances with derived orientation.

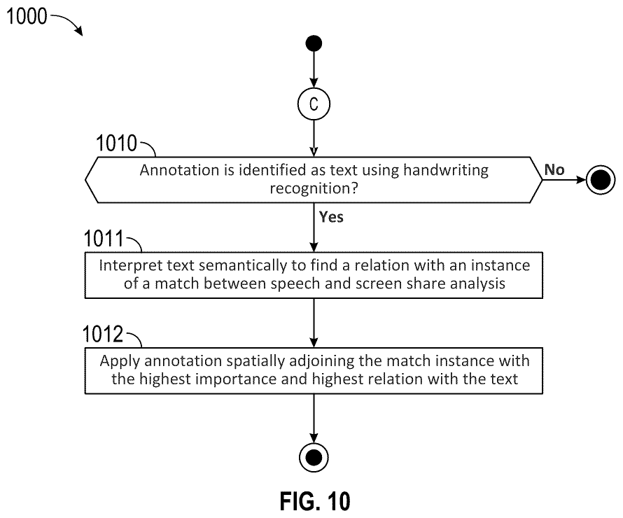

FIG. 10 is a flowchart that illustrates text processing 1000, in accordance with some embodiments of this disclosure. As shown in FIGS. 1-9, system 1000 provides for automatically placing an annotation by receiving at least one of a voice input, gesture input, and media input. In some embodiments, the systems 1000 and method described herein may be similar to the example illustrated in FIG. 3.

The components listed and depicted in FIG. 10 may be similar or have the same or similar features as components described above, and therefore the description of similar features may be omitted for brevity.

At step 1010, the system 1000 may determine whether annotation is identified as text, using a handwriting recognition algorithm. At step 1011, if text is positively identified, the system may interpret one or more elements of the text semantically to find a relationship with an instance of a match between speech and screen share analysis. Subsequently, at step 1012, the system 1000 may apply annotation spatially adjoining the match instance with the highest importance and highest relation with the text.

In any of the system methods described herein (e.g., FIGS. 7-10), it should be appreciated that when multiple distinct annotations are received in succession, the system may evaluate whether one annotation serves to qualify or modify another. For example, upon receiving a circular gesture followed by a free-text input, the system may infer that the text is intended to qualify the content identified within the circular gesture. The system may further determine, based on contextual speech analysis, that the text is semantically related to the matched visual element identified by the circle. Accordingly, the system may position the text annotation in proximity to the matched visual element, while rendering the circle to enclose or highlight the same element.

In a similar manner, the system 1000 may recognize an arrow gesture followed by a text annotation. In such cases, the system may interpret the text as representing the intended termination point of the arrow. Accordingly, the system 1000 may identify a single instance of a visual entity-based on speech and video analysis—to serve as the originating point of the arrow. The arrow may then be rendered to extend from the identified visual entity toward the subsequently provided text annotation, thereby visually conveying a directional or relational link between the two.

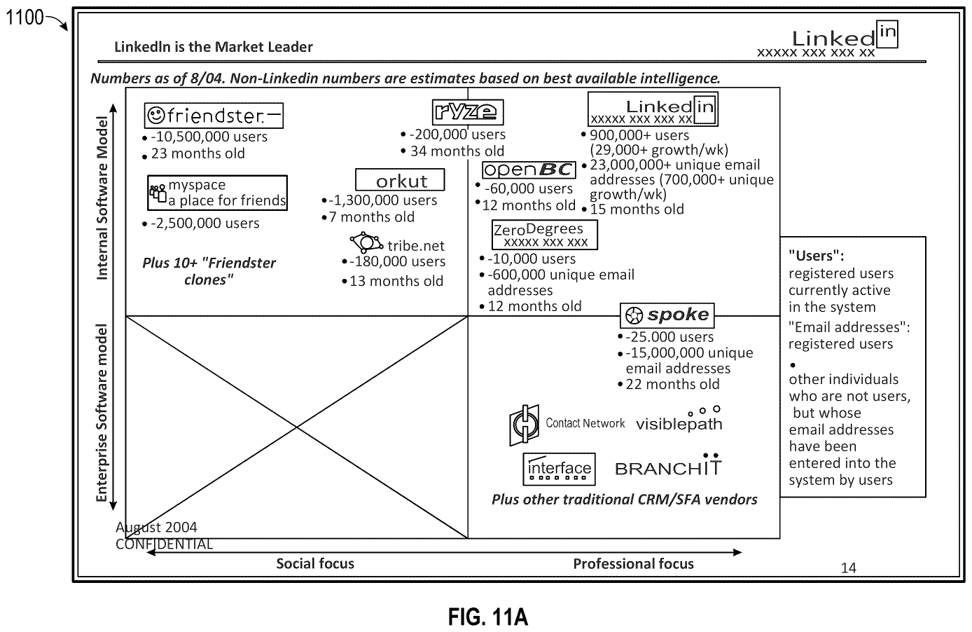

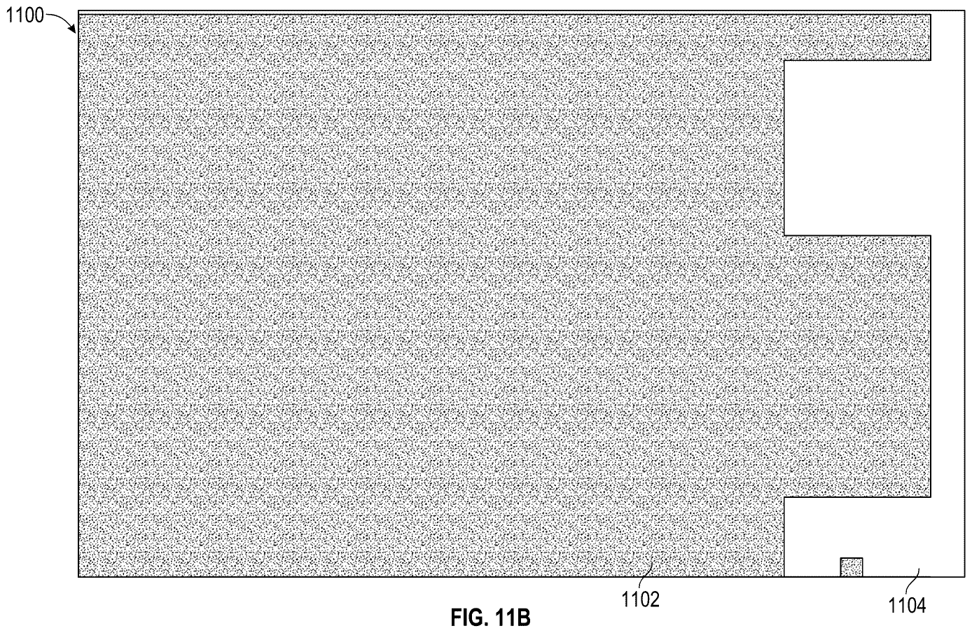

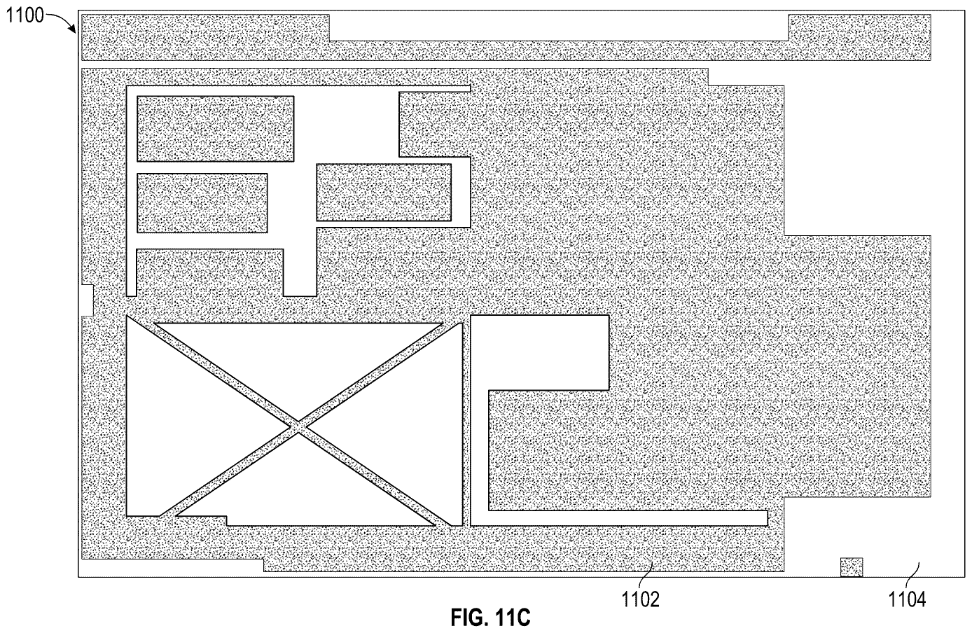

FIGS. 11A-11B illustrate black space determination with different saliency thresholds, in accordance with some embodiments of this disclosure. Specifically, FIG. 11A depicts a screen share, FIG. 11B depicts black space determination with low saliency threshold, and FIG. 11B depicts granular black space determination with higher saliency threshold. The components listed and depicted in FIGS. 11A-11B may be similar have the same or similar features as the components described above, and therefore the description of similar features may be omitted for brevity.

When generating an annotation, when selecting one or more portions of the presentation content to annotate, and/or when positioning an annotation, the system 1100 may attempt to minimize occlusions of text, images, video, etc., of the screen share or the electronic file. In some instances, to minimize occlusions of text or the like, the system 1100 may perform a white space analysis of the screen share. The system 1100 may then identify a black space (e.g., where saliency above a (low) threshold exists) and the remaining region is identified as the white space.

In some instances, the system 1100 may default to apply an annotation to the determined/identified white space. The system 1100 may scale and orient the text, optionally refining it using font-style matching, such that it fits within the white space adjacent to the relevant placement region (e.g., a matched visual entity).

For shape-based annotations involving a single target entity e.g., circles, rectangles, or other enclosures where the annotation must be placed within a visually salient (black space) region, the system 1100 may raise the saliency threshold to perform a more granular whitespace analysis. This may allow the system 1100 to determine whether a smaller or more constrained white space exists near the target entity where the annotation can be placed with minimal occlusion. In scenarios involving highlight annotations, the system 1100 may apply a degree of transparency to the highlight to ensure that the underlying content remains visible and discernible, thereby preserving legibility while still emphasizing the selected region.

In some embodiments, the text can be oriented and scaled (e.g., reducing font size) to fit the white space adjoining the determined placement region (e.g., a matched entity). For single entity annotations such as circles, boxes etc., if the annotation must lie in the black space, the saliency threshold may be raised to determine the white space more granularly. The goal of raising the saliency threshold is to determine whether the circle/box, etc., can be placed in a white space around the entity even if that space is more confined/narrower.

In some embodiments, when a highlight is used as an annotation, the system 1100 may change the transparency to ensure that the highlighted entity is visible in contrast to the black and white spaces.

FIGS. 11A-11C illustrate how using different saliency thresholds may be used to determine black space (e.g., after applying Otsu's thresholding to a saliency map), and therefore identifies white space.

In some embodiments, the system 1100 begins by identifying the screen share 1100 exemplified in FIG. 11A.

FIG. 11B depicts an example of how applying a saliency with a low threshold (e.g., low resolution) may look. The system 1100 shows that the screen share 1100 includes larger black spaces 1102 to white space 1104 ratio.

FIG. 11C depicts an example of how applying a saliency with a high threshold (e.g., high resolution) may look. The illustration shows that the screen share 1100 includes a smaller black spaces 1102 to white space 1104 ratio. As the algorithm increases resolution of the saliency, more granular black space 1102 determination can be used to place single entity annotations like boxes/circles such that they minimize occlusions the white space increases and therefore more of the annotation (even if confined/surrounded by black space) can lie in a white space 1104.

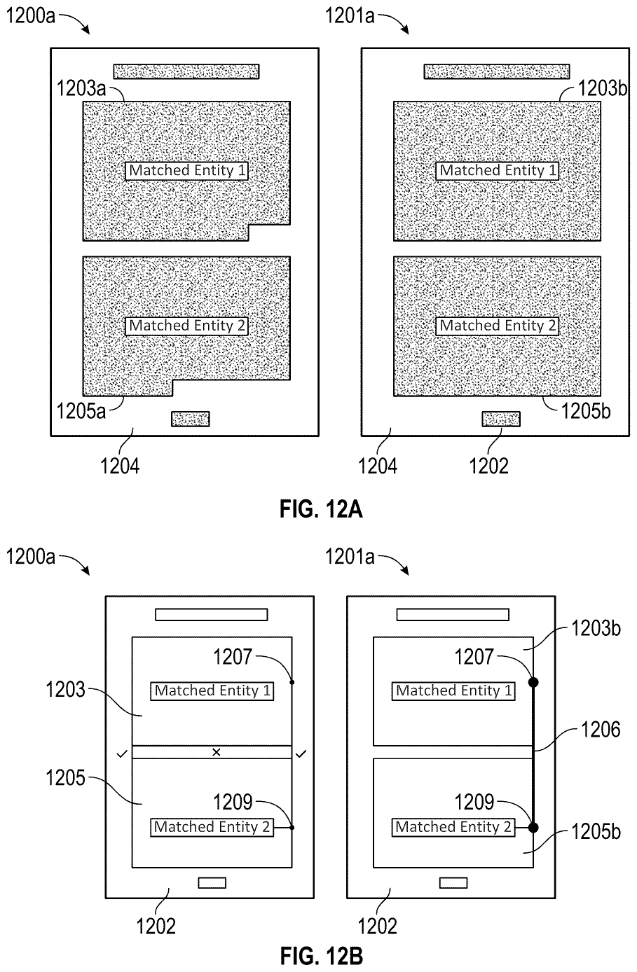

FIGS. 12A-12B illustrates a process for determining connector shapes between two entities to minimize occlusion, in accordance with some embodiments of this disclosure. Specifically, FIG. 12A depicts a matched entity black space converted to rectangles and FIG. 12B depicts road segments added to matched entity road networks to connect matching entities.

Similar to the example illustrated in FIGS. 11A-11C, FIGS. 12A-12B comprise black space 1202 and white space 1204 overlapping content on a respective screen share 1200a and 1200b. In some embodiments, a connector is generated between two matched entities (e.g., a first entity 1203 and a second entity 1205) on a screen share 1200a. To place a connector between two matched entities on a screen share, and to minimize occlusions, the method may involve first, dividing the screen share 1200 into black space(s) 1203a, 1205a and white space 1204. In some instances, generating a black space (e.g., determining and/or identifying a black space using a saliency threshold) over the screen share will result in incomplete shapes (e.g., 1203a, 1205a). In order to join the entities with minimal turns of the connector line (or, e.g., connector arrow, etc.), all black spaces may be converted into a similar, completed archetypal shape (e.g., rectangle, triangle, square, or similar). In FIG. 12A, the incomplete rectangular shape (1203a, and 1203b) may be transformed into completed rectangles (1205b, and 1205b), respectively.

Secondly, as depicted in FIG. 12B, two points on white spaces, near the two matched entities (e.g., 1207, and 1209) may be generated on the edge of the matched entity. Thereafter, a road network 1206 may be generated between the two points (1207, and 1209) utilizing the border or the rectangular black space (e.g., 1203b and 1205b). The connecting lines 1206 between the two points is termed road segment 1206. The length of the road segment 1206 is minimized, and the length of an existing road in the network is maximized, (e.g., added to an existing road segment to extend the road segment).

In some embodiments, a pathfinding algorithm is utilized to determine a fewest-turn-shortest-path.

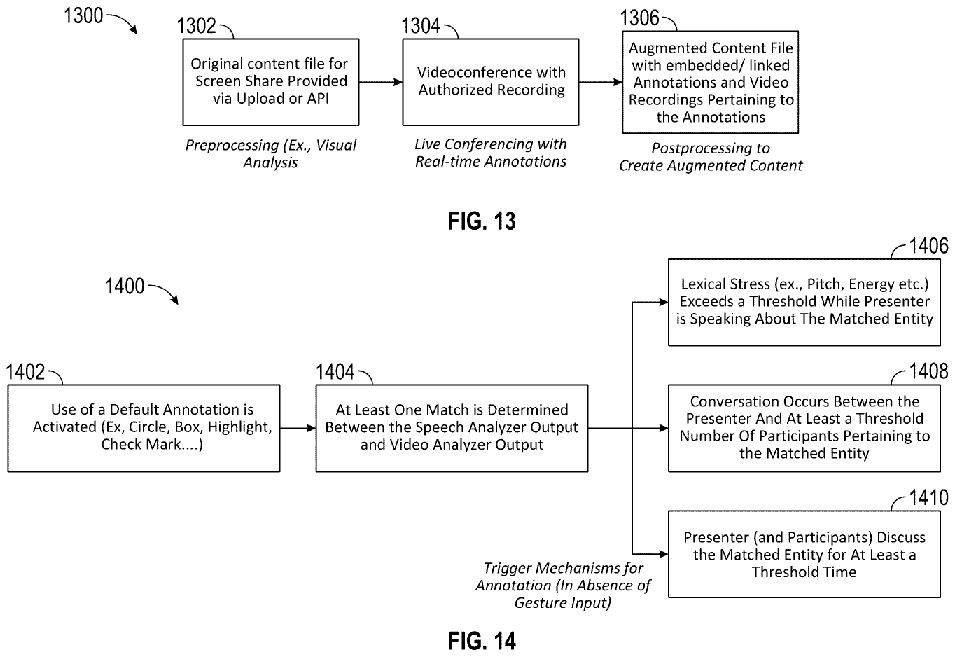

FIG. 13 is a flowchart depicting a method to create augmented content, in accordance with some embodiments of this disclosure. In some embodiments, the method 1300 described herein may be similar to systems (or to the examples illustrated in FIGS. 1-3) herein.

The components listed and depicted in FIG. 13 may be similar have the same or similar features as the components described above, and therefore the description of similar features may be omitted for brevity. The method begins at step 1302 where an original content file (e.g., for screen share) is provided to the system 1300 (e.g., via upload and/or API).

At step 1304, the system 1300 provides a videoconference with authorized recording (e.g., live conferencing with real-time annotations), or provides services for a videoconferencing or other presentation application.

At step 1306, the system 1300 transmits an augmented content file (e.g., with embedded/linked annotations and video recordings) pertaining to the annotation. At this step, post-processing may be done to create augmented content.

In some embodiments, when an electronic file is provided to the videoconferencing platform via an upload or API, the videoconferencing system may store in memory one or more interactions during the screen share that led to an annotation. In some instances, these interactions may include audio and/or video that pertain to the annotation. In some embodiments, these interactions may be separately downloadable in a recording of the videoconference, or they may be marked/annotated on the timeline of the stored videoconference.

In some instances, since the videoconferencing platform may store the original electronic file available, it may qualify these interactions beyond the time stamp (e.g., as a slide number or page number). In some embodiments, the system 1300 may embed these interactions into the original file or associate them with links/URLs that are cross-referenced in an augmented version of the original content file (e.g., created by the videoconferencing platform). In this example, the system 1300 allows its participants and administrators (e.g., presenter) to have a version of a presentation/document/media file that has the annotations as well as the recordings associated with the annotations.

The system 1300 may present the recording in picture-in-picture (PiP) mode with automatic trick-play as a user/reviewer interacts with different portions of a document (e.g., a specific bullet point on a slide). In one example, a user may go back to the version of a slide deck to make edits on all the recordings for every slide with an annotation, this means that the system may present the user supplemental data (e.g., including those questions that were determined to pertain to a slide during a Q&A). In this example, a user may change the recording per slide, including video related to the slide, even if the slide wasn't being displayed (e.g., during later Q&A). In some instances, the user who is watching the stored presentation may choose to review it with or without the annotations that had been generated. In some embodiments, the presenter may also have the option to further modify the augmented content by wiping out or altering the existing annotations in the previous version of the media file. In some embodiments, the consumer of the stored presentation may add additional annotations (e.g., using speech or other input and hand gestures) to modify further the stored annotated presentation.

FIG. 14 is a flowchart depicting a method 1400 for triggering mechanisms for annotation when automatic/default annotation mode is enabled, in accordance with some embodiments of this disclosure. In some embodiments, the method 1400 may be provided by systems described herein and used for one or more of the examples (e.g., examples illustrated in FIGS. 1-3) herein.

The components listed and depicted in FIG. 14 may be similar or have similar features as the components described above, and therefore the description of similar features may be omitted for brevity.

The method begins at step 1402, where a default annotation (e.g., circle, box, highlight or similar annotation previously stored by the system) may be activated based on a hand gesture.

At step 1404, at least one match is determined by the system 1400 between the speech analyzer output and video analyzer output.

At this step, the system 1400 may choose to go to either one or more routes (e.g., 1406, 1408, and 1410) to determine whether to insert an annotation. Such determinations may be made without detection of a hand gesture input or may be used to determine what semantic content the detected hand gesture is likely intended for. At 1406, lexical stress (e.g., pitch, energy or similar) may be determined to exceed a threshold while the presenter is speaking about the matched entity. At 1408, the conversation may occur between the presenter and at least a threshold number of participants pertaining to the matched entity. At 1410, the presenter and participants may discuss the matched entity for at least a threshold time. The annotation may be positioned based on such detection of the emphasis (e.g., 1406, 1408, 1410) of semantic content.

In some embodiments, the system 1400 provides a presenter a default annotation that may be automatically inserted without a gesture analysis (e.g., to a single entity on the screen share). In some embodiments, the system 1400 may be triggered when the speech analyzer detects lexical stress patterns by the presenter that exceed a threshold, or a conversation occurs between the presenter and one or more participants on a subject pertaining to a match between speech and video analysis, or if the presenter's treatment of a particular subject that is a match between speech and video analysis exceeds a time threshold.

In some embodiments, the system 1400 is not able to place the annotation, even if it finds a single unambiguous candidate for the annotation. In response, the system 1400 may activate a manual mode for the presenter. In some embodiments, this may occur when the system 1400 determines that the intrinsic nature of the annotation does not agree with the matches that are determined. For example, the system 1400 determines that the user has drawn a circle, however, there is no match derived from speech and video analysis. This may be understood to mean that the user was mistaken about the screen share content, or did not provide an appropriate cue to the system on what needed to be encircled. In another example, the system recognizes a user-drawn arrow but determines that there is only one match in the speech and video analysis.

The system 1400 may pause to receive another annotation, which could be text to terminate the arrow; however, if the user does not enter it within a certain time window, then the system 1400 may find the input inconclusive.

For example, in the manual mode, the annotation may be placed at a preset location on the screen share. In some embodiments, the user may control the annotation by dragging it, orienting it and scaling it in free space, such that their control is reflected in real time/near real time on the screen share.

In some embodiments, the system 1400 is implemented for an in-person live presentation rather than a videoconferencing platform. In this scenario, the speech analyzer, video analyzer and gesture analyzer (whether local or in the cloud) receive input from the presenter at the location where they are presenting.

In some embodiments, the system 1400 may privately request the presenter to select from a few options for placing and orienting the annotation, or it may request a confirmation from the presenter before applying the annotation to the screen share. This may provide error resilience during a high stakes presentation or videoconference. This option may be a default setting on the system 1400, or it may be enabled by a presenter based on their preference for a particular videoconference. It may also be used by the presenter to pick whether they want their original annotation as captured by a 3D sensor device to be displayed, or they want to modify the annotation, for example, to eliminate human movement tracing imperfections or to blend with an existing font or visual theme already on display in the screen share. This may also be used by the system 1400 to reduce computational complexity. For example, the system 1400 may determine multiple instances of a match from speech and video analysis on a screen share. Instead of picking one of those matches based on importance ranking/saliency, it may provide multiple options to the user so they can select the appropriate option.

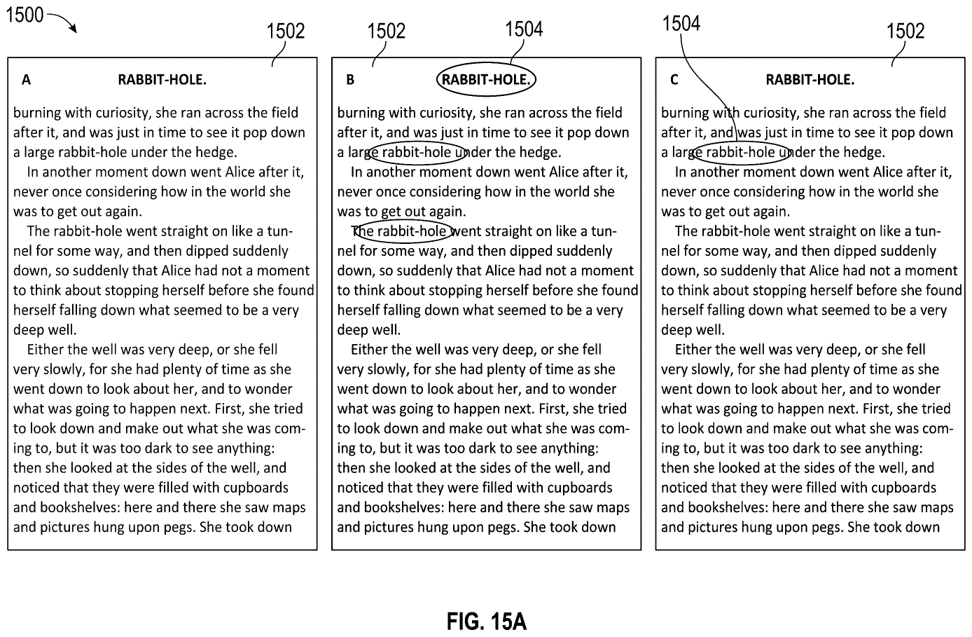

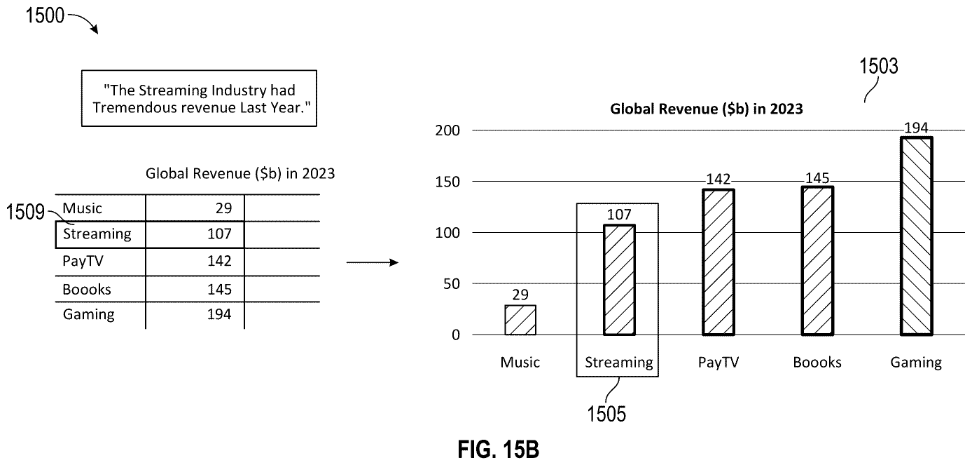

FIGS. 15A-15B depict use case examples, in accordance with some embodiments of this disclosure. Specifically, FIG. 15A depicts displaying multiple options to a presenter, and 15B depicts how the system may identify specific references in data visualization. In some embodiments, the systems 1500 and method described herein may be the same or similar to any system (e.g., system 100 illustrated in FIG. 1) herein.

The components listed and depicted in FIGS. 15A-15B may be similar have the same or similar features as the components described above, and therefore the description of similar features may be omitted for brevity.

FIG. 15A depicts an example, where the system 1500 attempts to determine a single unambiguous match for annotation between speech analysis and video analysis (e.g., “rabbit-hole”). In some embodiments, the system 1500 may determine that all the occurrences of the word “rabbit-hole” are equally relevant (e.g., none of them is a clear winner in importance ranking based on saliency or other measures). Therefore, one option presented by the system is a private view of all possible selections of the word to the presenter, who may then choose only one (or a plurality). FIG. 15A displays three options (e.g., options A, B and C) to the presenter for displaying on the screen share 1502. In this example, the system 1500 may solicit user feedback privately (e.g., to the presenter's personal device) prior to displaying an inferred annotation with its placement, scaling and orientation publicly on the screen share.

In some embodiments, option A is presented to give an option to provide no annotation. In some embodiments, option B is presented with annotations 1504 over all instances of the identified matched identity (e.g., rabbit-hole). In some embodiments, the speech analyzer may determine that a single instance of the screen share 1502 is most important and highlight the most important instance.

In some embodiments, the annotation can be formatted differently (e.g., bolder/different color) to each participant (e.g., based on their own settings). A presenter may also enable annotations with greater or lesser visual salience (e.g., thicker vs. thinner outline, bold/italic vs. regular font) as determined by the speech analyzer.

FIG. 15B depicts a screen share 1503, annotation 1505, and correlating speech from the presenter 1507 (e.g., “The streaming industry had a tremendous revenue last year”).

In the provided example, the presenter may say, “It is important to highlight that revenue grew by 5% and operating costs were reduced by 2%”—this may communicate to the system 1500 to provide bolder annotation graphics (e.g., 1504, 1509 and/or 1505). In another example, participants may also annotate a screen share to each other by selecting specific users (e.g., in a private messaging/side-conversation between some participants occurring during a videoconference). This may occur, if some participants are not on camera and muted for the (public) videoconference. In this mode, the participants can privately activate speech recording via their microphone and perform a gesture. The system 1500 may detect their gestures, determine matches between their private speech and the public screen share and apply the gesture as an annotation for private delivery to another participant. As discussed, the user gesture from the one or more participants may be detected by the system 1500 in one or more of a variety of ways (e.g., stylus, camera, etc.).

In some embodiments, the system 1500 may comprise a corresponding chat message application. The chat messages may be between each participant (e.g., participant and presenter) of the screen share application and may be used by the system 1500 to place annotations (e.g., 1505, 1504, 1509). For example, continuing in the illustration of FIG. 15B, the system 1500 may have already successfully annotated 1505 the streaming segment of the chart 1503. As the presenter is continuing to present information, a participant may write in the chat application, “Change the bar graph color over gaming to be pink,” and the system may respond by automatically updating the color of the bar graph or requesting permission by the presenter to apply said changes. In other embodiments, the system 1500 may send chat messages to the speech analyzer to use in its annotation placement algorithm. In some implementations of system 1500, the visual appearance of an object—such as chart 1503—and its annotations 1505 can vary from one participant to another. Because color and style are intrinsic properties of these objects, each user can apply personal display preferences that override the presenter's original formatting. For example, a participant who sets all objects to render in pink will see chart 1503 and corresponding bar graphs in pink, while the presenter continues to view them in their original colors. These transformations may be performed during server-side preprocessing of the video frame or locally on the client device. Since charts and similar elements are recognized as discrete computerized objects, their color, format, and style can be modified at either processing stage.

In some embodiments, annotation and/or any additional elements added by the system may be configured to each respective user's preferences. For example, a user may set personalized setting where annotations on their screen are generated in pink or any suitable color and/or style.

In some embodiments, the system 1500 may provide a videoconference using extended reality (XR) glasses. For example, any of the participants and/or presenter may use an XR head mounted display (HMD) to display the screen share (e.g., 102, 202 or 302). In an XR context, one or more HMD external camera(s) may detect hand gestures.

In some embodiments, the system 1500 may apply similar methods to annotate specific elements of a data visualization (e.g., bar graph, line chart). First, the system 1500 may identify that the user is referring to a data visualization by considering other annotation candidates and determining that their confidence values fall below a threshold value. The system 1500 may also compare the difference in confidence values between the data visualization and other chart elements and only select the data visualization if the difference exceeds a threshold.

Specific features of detected speech may influence this selection process, such as numbers (e.g., “40 out of 100 users liked this feature”) or mathematical operations (e.g., When you remove non-respondents from this group, you end up with 50 participants). The system 1500 may identify such values and operations and increase its confidence in the data visualization annotation candidate.

Once a data visualization has been selected as the likely candidate for annotation, the system 1500 may extract the underlying data. In the case of a linked chart populated from a spreadsheet, depicted in FIG. 15B, the system may retrieve the source data and analyze that directly. In some embodiments, if the source data is not available, the system 1500 may apply existing methods to extract data from the graph image.

With graph data and visual references identified, the system 1500 may determine which graph element a user is referring to by extracting numerical and mathematical operations from their speech transcript. In the case of a single number (e.g., “We made $10m last year”), the system 1500 may search graph data for that value, identify its referent on the graph and use the methods described above to annotate it. If no direct match is found, the system 1500 may select the closest numerical value. Alternatively, the system 1500 may round off the numbers in the extracted data, identify candidates, and select the most likely one (which may be the most relevant despite not being numerically the closest).

In another example, there may be more complex references involving mathematical operations. The system 1500 may apply existing methods to extract equations from the user's speech transcript. In the case of a linked chart, the system 1500 may attempt to match the equation to the equations used to fill cells. If no linked chart is available, the system may attempt to infer equations based on underlying data. For example, if a user says “When we remove non-respondents from this group, you end up with 50 participants,” the system 1500 may identify the number 50 and attempt to find data pairs that subtract to 50.

In some embodiments, the system 1500 may consider slide format (e.g., text boxes arranged horizontally, bullet points descending vertically), slide elements (e.g., a right-pointing arrow), and annotation history (e.g., the user went left-to-right in a previous slide with a similar format) to inform annotation candidate selection. Slides are often presented top down or left to right, and such slide format patterns are relatively simple to identify. Slide elements may similarly inform annotation candidate selection. For example, if a user is presenting a development timeline chart with project milestones marked on an arrow pointing to the right, the system 1500 may be confident that the next slide element will be the next item on the right.

Annotation history may also be relevant when selecting an annotation candidate, particularly for repeated slide formats. For example, if a presentation includes multiple slides containing a quad chart and for every previous quad chart slide the user has started in the top left corner and moved clockwise through the panels, the system may increase confidence levels for annotations in those locations sequentially.

FIGS. 16-17 describe illustrative devices, systems, servers, and related hardware for providing audio from a live event to a user, in accordance with some embodiments of the present disclosure.

FIG. 16 shows generalized embodiments of illustrative user equipment 1600 and 1601, which may correspond to, e.g., user equipment 114 and/or 106 of FIGS. 1-3; user equipment 214 and/or 206 of FIG. 2; user equipment 314 and/or 306 of FIG. 5. For example, user equipment 1600 may be a smartphone device, a tablet, a near-eye display device, an XR device, or any other suitable device capable of participating in a XR environment, e.g., locally or over a communication network. In another example, user equipment 1601 may be a user television equipment system or device. User equipment 1601 may include set-top box 1616. Set-top box 1616 may be communicatively connected to microphone 1617, audio output equipment (e.g., speaker or headphones 1614), and display 1612. In some embodiments, microphone 1617 may receive audio corresponding to a voice of a video conference participant and/or ambient audio data during a video conference. In some embodiments, display 1612 may be a television display or a computer display. In some embodiments, set-top box 1616 may be communicatively connected to user input interface 1610. In some embodiments, user input interface 1610 may be a remote-control device. Set-top box 1616 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 17. In some embodiments, device 1600 may comprise any suitable number of sensors (e.g., gyroscope or gyrometer, or accelerometer, etc.), and/or a GPS module (e.g., in communication with one or more servers and/or cell towers and/or satellites) to ascertain a location of device 1600. In some embodiments, device 1600 comprises a rechargeable battery that is configured to provide power to the components of the device.

Each one of user equipment 1600 and user equipment 1601 may receive content and data via input/output (I/O) path 1602. I/O path 1602 may provide content (e.g., broadcast programming, on-demand programming, internet content, content available over a local area network (LAN) or wide area network (WAN), and/or other content) and data to control circuitry 1604, which may comprise processing circuitry 1607 and storage 1608. Control circuitry 1604 may be used to send and receive commands, requests, and other suitable data using I/O path 1602, which may comprise I/O circuitry. I/O path 1602 may connect control circuitry 1604 (and specifically processing circuitry 1607) to one or more communications paths (described below). I/O functions may be provided by one or more of these communications paths but are shown as a single path in FIG. 16 to avoid overcomplicating the drawing. While set-top box 1616 is shown in FIG. 16 for illustration, any suitable computing device having processing circuitry, control circuitry, and storage may be used in accordance with the present disclosure. For example, set-top box 1616 may be replaced by, or complemented by, a personal computer (e.g., a notebook, a laptop, a desktop), a smartphone (e.g., device 1600), an XR device, a tablet, a network-based server hosting a user-accessible client device, a non-user-owned device, any other suitable device, or any combination thereof.

Control circuitry 1604 may be based on any suitable control circuitry such as processing circuitry 1607. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 604 executes instructions for the media application stored in memory (e.g., storage 1608). Specifically, control circuitry 1604 may be instructed by the media application to perform the functions discussed above and below. In some implementations, processing or actions performed by control circuitry 1604 may be based on instructions received from the media application.

In client/server-based embodiments, control circuitry 1604 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 16, the instructions may be stored in storage 1608 and executed by control circuitry 1604 of a device 1600.

In some embodiments, the media application may be a client/server application where only the client application resides on device 1600, and a server application resides on an external server (e.g., server 1704 and/or media content source 1702). For example, the media application may be implemented partially as a client application on control circuitry 1604 of device 1600 and partially on server 1704 as a server application running on control circuitry 1711. Server 1704 may be a part of a local area network with one or more of devices 1600, 1601 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 1704 and/or an edge computing device), referred to as “the cloud.” Device 1600 may be a cloud client that relies on the cloud computing capabilities from server 1704 that hosts the video conferencing platform (e.g., 603 of FIG. 6). The client application may instruct control circuitry 1604 to of each element of the video conferencing platform to receive gesture, speech and video content, to analyze (e.g., by a video decoder 611, speech analyzer 605, video analyzer 604, gesture analyzer 606 and/or integrating processing module 612 of FIG. 6) and output (e.g., by video encoder 610 of FIG. 6) an annotation.

Control circuitry 1604 may include communications circuitry suitable for communicating with a server, edge computing systems and devices, a table or database server, or other networks or servers. The instructions for carrying out the above-mentioned functionality may be stored on a server (which is described in more detail in connection with FIG. 17). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 17). In addition, communications circuitry may include circuitry that enables peer-to-peer communication of user equipment, or communication of user equipment in locations remote from each other (described in more detail below).

Memory may be an electronic storage device provided as storage 1608 that is part of control circuitry 1604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1608 may be used to store various types of content described herein as well as media application data described above. Nonvolatile memory may also be used (e.g., to launch a boot-up routine and other instructions). Cloud-based storage, described in relation to FIG. 16, may be used to supplement storage 1608 or instead of storage 1608.

Control circuitry 1604 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1604 may also include scaler circuitry for upconverting and downconverting content into the preferred output format of user equipment 1600. Control circuitry 1604 may also include digital-to-analog converter circuitry and analog-to-digital converter circuitry for converting between digital and analog signals. The tuning and encoding circuitry may be used by user equipment 1600, 1601 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1608 is provided as a separate device from user equipment 1600, the tuning and encoding circuitry (including multiple tuners) may be associated with storage 1608.

Control circuitry 1604 may receive instruction from a user by way of user input interface 1610. User input interface 1610 may be any suitable user interface, such as a remote control, mouse, trackball, keypad, keyboard, touch screen, touchpad, stylus input, joystick, voice recognition interface, or other user input interfaces. Display 1612 may be provided as a stand-alone device or integrated with other elements of each one of user equipment 1600 and user equipment 1601. For example, display 1612 may be a touchscreen or touch-sensitive display. In such circumstances, user input interface 1610 may be integrated with or combined with display 1612. In some embodiments, user input interface 1610 includes a remote-control device having one or more microphones, buttons, keypads, any other components configured to receive user input or combinations thereof. For example, user input interface 1610 may include a handheld remote-control device having an alphanumeric keypad and option buttons. In a further example, user input interface 1610 may include a handheld remote-control device having a microphone and control circuitry configured to receive and identify voice commands and transmit information to set-top box 1616.

Audio output equipment 1614 may be integrated with or combined with display 1612. Display 1612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1612. Audio output equipment 1614 may be provided as integrated with other elements of each one of device 1600 and device 1601 or may be stand-alone units. An audio component of videos and other content displayed on display 1612 may be played through speakers (or headphones) of audio output equipment 1614. In some embodiments, audio may be distributed to a receiver (not shown), which processes and outputs the audio via speakers of audio output equipment 1614. In some embodiments, for example, control circuitry 1604 is configured to provide audio cues to a user, or other audio feedback to a user, using speakers of audio output equipment 1614. There may be a separate microphone 1617 or audio output equipment 1614 may include a microphone configured to receive audio input such as voice commands or speech. For example, a user may speak letters or words that are received by the microphone and converted to text by control circuitry 1604. In a further example, a user may voice commands that are received by a microphone and recognized by control circuitry 1604. Camera 1618 may be any suitable video camera integrated with the equipment or externally connected. Camera 1618 may be a digital camera comprising a charge-coupled device (CCD) and/or a complementary metal-oxide semiconductor (CMOS) image sensor. Camera 1618 may be an analog camera that converts to digital images via a video card.

The media application may be implemented using any suitable architecture. For example, it may be a stand-alone application wholly implemented on each one of user equipment 1600 and user equipment 1601. In such an approach, instructions of the application may be stored locally (e.g., in storage 1608), and data for use by the application is downloaded on a periodic basis (e.g., from an out-of-band feed, from an internet resource, or using another suitable approach). Control circuitry 1604 may retrieve instructions of the application from storage 1608 and process the instructions to provide video conferencing functionality and generate any of the displays discussed herein. Based on the processed instructions, control circuitry 1604 may determine what action to perform when input is received from user input interface 1610. For example, movement of a cursor on a display up/down may be indicated by the processed instructions when user input interface 1610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1604 may allow a user to provide user profile information or may automatically compile user profile information. For example, control circuitry 1604 may access and monitor network data, video data, audio data, processing data, participation data from a conference participant profile. Control circuitry 1604 may obtain all or part of other user profiles that are related to a particular user (e.g., via social media networks), and/or obtain information about the user from other sources that control circuitry 1604 may access. As a result, a user can be provided with a unified experience across the user's different devices.

In some embodiments, the media application is a client/server-based application. Data for use by a thick or thin client implemented on each one of user equipment 1600 and user equipment 1601 may be retrieved on-demand by issuing requests to a server remote to each one of user equipment 1600 and user equipment 1601. For example, the remote server may store the instructions for the application in a storage device. The remote server may process the stored instructions using circuitry (e.g., control circuitry 1604) and generate the displays discussed above and below. The client device may receive the displays generated by the remote server and may display the content of the displays locally on device 1600. This way, the processing of the instructions is performed remotely by the server while the resulting displays (e.g., that may include text, a keyboard, or other visuals) are provided locally on device 1600. Device 1600 may receive inputs from the user via input interface 1610 and transmit those inputs to the remote server for processing and generating the corresponding displays. For example, device 1600 may transmit a communication to the remote server indicating that an up/down button was selected via input interface 1610. The remote server may process instructions in accordance with that input and generate a display of the application corresponding to the input (e.g., a display that moves a cursor up/down). The generated display is then transmitted to device 1600 for presentation to the user.

In some embodiments, the media application may be downloaded and interpreted or otherwise run by an interpreter or virtual machine (run by control circuitry 1604). In some embodiments, the media application may be encoded in the ETV Binary Interchange Format (EBIF), received by control circuitry 1604 as part of a suitable feed, and interpreted by a user agent running on control circuitry 1604. For example, the media application may be an EBIF application. In some embodiments, the media application may be defined by a series of JAVA-based files that are received and run by a local virtual machine or other suitable middleware executed by control circuitry 1604. In some of such embodiments (e.g., those employing MPEG-2,MPEG-4, HEVC or any other suitable digital media encoding schemes), the media application may be, for example, encoded and transmitted in an MPEG-2 object carousel with the MPEG audio and video packets of a program.

As shown in FIG. 17, user equipment 1706, 1707, 1708, 1710 (which may correspond to, e.g., e.g., user equipment 114 and/or 106 of FIG. 1; user equipment 214 and/or 206 of FIG. 2; user equipment 314 and/or 306 of FIG. 3 user equipment may be coupled to communication network 1709. Communication network 1709 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1709) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 17 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 1709.

System 1700 may comprise media content source 1702, one or more servers 1704, and/or one or more edge computing devices. In some embodiments, the media application may be executed at one or more of control circuitry 1711 of server 1704 (and/or control circuitry of user equipment 1706, 1707, 1708, 1710 and/or control circuitry of one or more edge computing devices). In some embodiments, the media content source and/or server 1704 may be configured to host or otherwise facilitate video communication sessions between user equipment 1706, 1707, 1708, 1710 and/or any other suitable user equipment, and/or host or otherwise be in communication (e.g., over network 1709) with one or more social network services.

In some embodiments, server 1704 may include control circuitry 1711 and storage 1714 (e.g., RAM, ROM, Hard Disk, Removable Disk, etc.). Storage 1714 may store one or more databases. Server 1704 may also include an I/O path 1712. I/O path 1712 may provide video conferencing data, device information, or other data, over a local area network (LAN) or wide area network (WAN), and/or other content and data to control circuitry 1711, which may include processing circuitry, and storage 1714. Control circuitry 1711 may be used to send and receive commands, requests, and other suitable data using I/O path 1712, which may comprise I/O circuitry. I/O path 1712 may connect control circuitry 1711 (and specifically control circuitry) to one or more communications paths.

Control circuitry 1711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1711 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1711 executes instructions for an emulation system application stored in memory (e.g., the storage 1714). Memory may be an electronic storage device provided as storage 1714 that is part of control circuitry 1711.

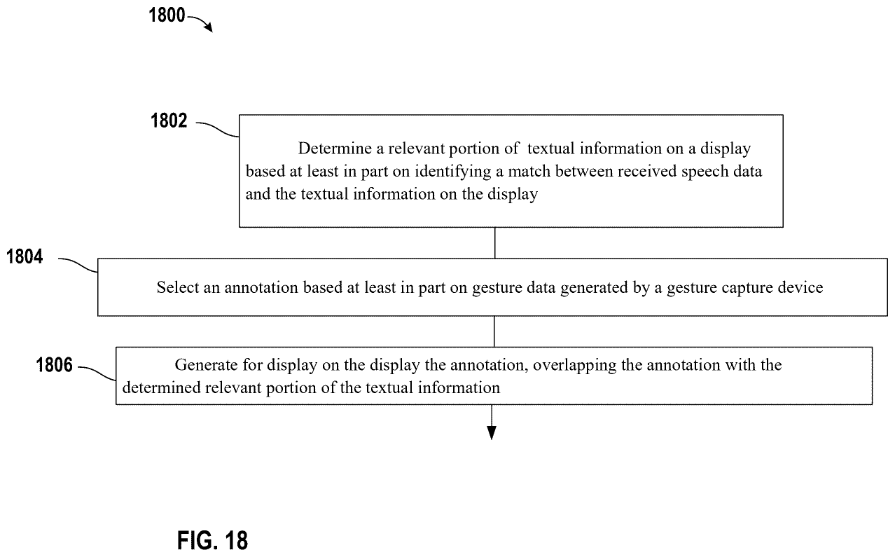

FIG. 18 is a flowchart illustrating a process for automating annotation on a screenshare or other type of presentation, in accordance with some embodiments of this disclosure. As shown in FIGS. 1-10, method 1800 provides for automatically placing an annotation by receiving at least one of a voice input, gesture input, and media input. In some embodiments, the method 1800 may be similar to examples illustrated in any of FIGS. 1-3.

The components listed and depicted in FIG. 18 may be similar or have the same or similar features as components described above, and therefore the description of similar features may be omitted for brevity.

In any of the system methods described herein (e.g., FIG. 7-10) , it should be appreciated that when multiple distinct annotations are received in succession, the system 1800 may evaluate whether one annotation serves to qualify or modify another. For example, upon receiving a circular gesture followed by a free-text input, the system may infer that the text is intended to qualify the content identified within the circular gesture. The system may further determine, based on contextual speech analysis, that the text is semantically related to the matched visual element identified by the circle. Accordingly, the system may position the text annotation in proximity to the matched visual element, while rendering the circle to enclose or highlight the same element.

The method 1800 begins at step 1802, at which the system determines a relevant portion of textual information provided in a visual display. The relevant portion of the textual information may be determined based at least in part on identifying a match semantic content comprised in or derived from speech data received from a speech-to-text module.

At step 1804, the system selects an annotation graphic previously stored, or generates an annotation, based at least in part on gesture data captured by a gesture capture device. At step 1806, the system generates for display the annotation at the determined relevant portion of the textual information.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

Unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments. Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

The systems and/or methods described above may be applied to, or used in accordance with, other systems and/or methods. In various embodiments, additional elements may be included, some elements may be removed, and/or elements may be arranged differently from what is shown. Alterations, modifications, combination, and variations may be made to the particular embodiments by those of skill in the art without departing from the scope of the present application, which is defined solely by the claims appended hereto.

1. A method comprising:
determining a relevant portion of textual information provided in a visual display, wherein the relevant portion of the textual information is determined based at least in part on semantic content comprised in speech data received from a speech-to-text module;
selecting an annotation based at least in part on gesture data generated by a gesture capture device; and
generating for display the annotation at the determined relevant portion of the textual information.

2. The method of claim 1, wherein the generating for display the annotation is performed as part of a live video conference and the speech data and gesture data are received during the live video conference.

3. The method of claim 1, wherein the determining the relevant portion of the textual information comprises determining, based on the semantic content comprised in the speech data, a first relevant portion of the textual information and a second relevant portion of the textual information, and wherein the annotation comprises generating a visual indication of a relationship between the first relevant portion and the second relevant portion.

4. The method of claim 1, wherein the gesture capture device generates gesture data based at least in part on an inertial measurement unit (IMU) sensor.

5. The method of claim 1, further comprising:
determining based at least in part on the gesture data that the textual information is to be modified according to the speech data, wherein the generating for display the annotation comprises at least one of striking through or removing alphanumeric information.

6. The method of claim 1, further comprising:
receiving gesture data indicating alphanumeric information generated based at least in part on captured human hand movement simulating writing; and
modifying the determined relevant portion of the textual information based at least in part on the indicated alphanumeric information.

7. The method of claim 1, wherein the gesture data and the speech data are received while the textual information is being displayed.

8. The method of claim 1, wherein the annotation is displayed as part of a video.

9. The method of claim 1, further comprising:
retrieving a user preference from a preference profile; and
generating for display the annotation comprising a version of the annotation, wherein the version of the annotation is selected based at least in part on the preference profile.

10. The method of claim 1, further comprising:
generating the textual information for display by a user device; and
generating for display the annotation by a second device on the user device.

11. The method of claim 1, wherein the selecting the annotation based at least in part on the gesture data generated by a gesture capture device comprises:
selecting as the annotation a graphical indication from a plurality of predetermined graphical indications.

12. The method of claim 1, wherein the relevant portion of the textual information is determined by identifying a match between speech data and the textual information.

13. A method comprising:
receiving presentation data for a visual display;
receiving speech data captured via a speech-to-text module;
receiving gesture data captured via a gesture capture device;
determining a correspondence between at least one semantic term identified based on the speech data and semantic content identified in the presentation data; and
determining an annotation based at least in part on the received gesture data;
generating for display the annotation, wherein the annotation is positioned on the visual display based at least in part on the determined correspondence.

14. The method of claim 13, wherein the presentation data comprises a plurality of encoded frames, and the method further comprising:
decoding at least one frame of the plurality of frames of the presentation data; and
processing the at least one frame of the plurality of frames to identify the semantic content in the presentation data.

15. The method of claim 13, wherein the semantic content identified in the presentation data is determined based at least in part on user profile data accessed in a database.

16. The method of claim 13, wherein the semantic content identified in the presentation data is determined based at least in part on user selection from multiple candidates.

17. The method of claim 13, wherein the received speech data captured via the speech-to-text module is parsed and transmitted to a natural language module to semantically tag and identify parts of speech.

18. The method of claim 13, wherein the gesture capture device is a camera, and the gesture data is generated based at least in part on a plurality of images captured by the camera.

19. The method of claim 18, wherein the camera is a LiDAR camera.

20. The method of claim 13, wherein the annotation is determined based at least in part on a trace in a 2D plane of a user gesture represented in the received gesture data.
